(19) United States
(12) Patent Application Publication
(10) Pub. No.: US 2014/0136627 A1
(43) Pub. Date: May 15, 2014

(54) METHOD AND SYSTEM FOR FACILITATING A MEETING

(71) Applicant: Paul EPSTEIN, Rose Bay (AU)

(72) Inventor: Paul EPSTEIN, Rose Bay (AU)

(21) Appl. No.: 14/099,735

(22) Filed: Dec. 6, 2013

Related U.S. Application Data
(63) Continuation of application No. PCT/AU2012/000657, filed on Jun. 8, 2012.
(60) Provisional application No. 61/494,638, filed on Jun. 8, 2011.

(51) Int. Cl. H04L 29/06

(52) U.S. Cl. CPC H04L 65/403
USPC 709/205

(57) ABSTRACT

Facilitating a meeting is described. The method comprises providing a network interface for receiving information via a network, and receiving, at the network interface, meeting information in respect of a meeting. The meeting information includes information that is indicative of at least one agenda item. The method also comprises providing a meeting structure information generator for generating meeting structure information based on received meeting information and generating, at the meeting structure information generator, meeting structure information based on the meeting information. The generated meeting structure information is provided to at least one meeting participant for use in facilitating the meeting. In a further step, agenda outcome information that is indicative of at least one outcome of the agenda item is received at the network interface. A meeting report information generator for generating meeting report information is used to generate meeting report information based on the received agenda outcome information.

### CROSS-REFERENCES TO RELATED APPLICATIONS

This application is a Continuation of PCT Application No. PCT/AU2012/000657, filed Jun. 8, 2012, which claims priority to provisional application, U.S. Ser. No. 61/494,638, filed Jun. 8, 2011, the contents of which are herein incorporated by reference in their entirety for all purposes into this application.

### FIELD

The present invention relates to a method and system for facilitating a meeting.

### BACKGROUND

Meetings can be used to make decisions and/or share information, and are considered to be an important part of business life. However, meetings are perceived to be generally inefficient and time wastage can occur during meetings. Some individuals may be experienced in running meetings, and may be able to improve the efficiency and/or effectiveness of a meeting. However, such individuals may not be available to run a meeting, or may not even be present in an organization.

### BRIEF SUMMARY

In accordance with a first aspect of the present invention, there is provided a method of facilitating a meeting, the method comprising the steps of:

providing a network interface for receiving information via a network;

receiving, at the network interface, meeting information in respect of a meeting, the meeting information including information that is indicative of at least one agenda item;

providing a meeting structure information generator for generating meeting structure information based on received meeting information;

generating, at the meeting structure information generator, meeting structure information based on the meeting information;

providing the generated meeting structure information to at least one meeting participant for use in facilitating the meeting;

receiving, at the network interface, agenda outcome information that is indicative of at least one outcome of the agenda item;

providing a meeting report information generator for generating meeting report information; and

generating, at the meeting report information generator, meeting report information based at least in part on the received agenda outcome information.

It will be appreciated that an agenda item may be an item for discussion, a focus topic or any other appropriate meeting item for discussion in a meeting.

The generated meeting report information may be communicated to meeting participants, for example in response to conclusion of the meeting.

The meeting structure information may be generated such that information indicative of a suggested time period is associated with the at least one agenda item. The information indicative of the suggested time period may be received from a user. For example, the received meeting outline information may comprise the information indicative of the suggested time period. Further, or alternatively, the information indicative of the suggested time period may be automatically generated in accordance with predefined time period information. In one example, the method comprises receiving information that is indicative of a suggested meeting time length, and the generated time period is based on the received meeting time length information.

The method may comprise tracking an amount of time spent on the at least one agenda item during the meeting, and generating an alert if the amount of time spent on the at least one agenda item exceeds the suggested time period associated with the at last one agenda item. An early warning alert may be generated prior to the suggested time period associated with the at least one agenda item being exceeded, for example when a predefined amount of time is left. The method may also comprise tracking a total amount of time spent on the meeting, and generating an alert if the total amount of time spent on the meeting exceeds the suggested meeting length time. An alert may be generated prior to the suggested meeting time length being exceeded, for example when a predefined amount of time is left.

The meeting structure information may be generated such that at least one predefined meeting step is associated with the at least one agenda item. The method may comprise prompting a meeting participant with information related to the at least one predefined meeting step so as to facilitate the at least one predefined meeting step being conducted. In one embodiment, a plurality of defined meeting steps are associated with the at least one agenda item, and the method comprises prompting the meeting participant with information associated with each meeting step so as to facilitate the predefined meeting steps being conducted.

The predefined meeting steps may be structured so as to facilitate the meeting progressing sequentially through the predefined meetings steps, and the generated meeting structure information may be arranged such that information associated with each predefined step is provided to a meeting participant in the sequential order of the predefined meeting steps. In one embodiment, the generated meeting structure information is arranged to facilitate tabling of each predefined meeting step. Information relating to each predefined meeting step can be received by the network interface, stored, and then included in the generated meeting report information.

The method may comprise receiving meeting information from one or more meeting participants and including the received meeting information in the generated meeting structure information. Further, or alternatively, the method may comprise receiving information in respect of an agenda item or a predefined meeting step from one or more meeting participants and including the received information in the generated meeting structure information.

The method may comprise receiving information indicative of a further agenda item and/or information associated with an agenda item, such as an outcome of an agenda item, in response to a meeting step being conducted. In one embodiment, the received information indicative of a further agenda item and/or information associated with an agenda item is included in the meeting report information.

The method may comprise a step of receiving a further agenda item and/or a modification to an existing agenda item and a step of generating the meeting structure information so as to incorporate the further agenda item and/or the modification to the existing agenda item.

In one embodiment, the meeting information comprises a meeting participant identifier for identifying a meeting participant, and the method comprises communicating a meeting request to the meeting participant based on the meeting participant identifier. The method may also comprise selecting a meeting participant for receiving a meeting request, and automatically sending a meeting request to the selected meeting participant.

The method may comprise providing meeting identification information to a requested meeting participant so as to enable the requested meeting participant to accept or decline the meeting request. In one embodiment, the method comprises communicating the meeting identification information to the requested meeting participant via the network interface, and the method comprises receiving at the network interface a response from the requested meeting participant to the meeting request. A response from each requested meeting participant may be stored, and information indicative of meeting attendees can be included in the generated meeting report information.

In one embodiment, the meeting outline information comprises time information indicative of a meeting time, and the method comprises communicating the meeting time to the meeting participant. In one example, the method comprises communicating meeting reminder information to the meeting participant at a time prior to the meeting time.

The method may comprise a step of receiving additional information, such as meeting attachments, associated with the meeting. The additional information may be stored and communicated to the meeting participant, for example when the meeting request is communicated to the meeting participant. The additional information may be provided to the meeting participant as a component of the meeting structure information.

The method may comprise receiving at least one action information item associated with a meeting item to be actioned, for example prior to a further meeting, and the method may comprise communicating the at least one action information item to a meeting participant. In one example, the method comprises receiving information indicative of a meeting participant selected to complete the action item, and the method comprises communicating the at least one action information item to the selected meeting participant. The method may also comprise receiving time information indicative of a suggested completion time of the at least one action item. The suggested completion time can be communicated to the selected meeting participant so as to facilitate the selected meeting participant completing the action item by the suggested completion time.

In accordance with a second aspect of the present invention, there is provided a system for facilitating a meeting, the system comprising:

a network interface that is in communication with a network, the network interface being arranged to receive, via the network, meeting outline information in respect of a meeting, the meeting outline information including at least one agenda item;

a meeting structure information generator arranged to generate meeting structure information based on the meeting outline information;

the system being arranged to:
communicate the generated meeting structure information to at least one meeting participant for use in facilitating the meeting; and
receive agenda outcome information that is indicative of at least one outcome of the agenda item;

the system further comprising a meeting report information generator arranged to generate meeting report information based at least in part on the received agenda outcome information.

In accordance with a third aspect of the present invention, there is provided a computer program arranged when loaded into a computing device to instruct the computer to operate in accordance with the method of the first aspect.

In accordance with a fourth aspect of the present invention, there is provided a computer readable medium having a computer readable program code embodied therein for causing a computing device to operate in accordance with the method of the first aspect.

In accordance with a fifth aspect of the present invention, there is provided a data signal having a computer readable program code embodied therein to cause a computing device to operate in accordance with the method of the first aspect.

### BRIEF DESCRIPTION OF THE DRAWINGS

The present invention will now be described, by way of example only, with reference to the accompanying drawings, in which:

FIG. 1 is a schematic diagram of a system for facilitating a meeting in accordance with an embodiment of the present invention;

FIG. 2 is a schematic diagram of a system for facilitating a meeting in accordance with an embodiment of the present invention;

FIGS. 3 to 35 are example screen shots produced by the system of FIG. 2; and

FIG. 36 is a flow diagram of a method of facilitating a meeting in accordance with an embodiment of the present invention.

### DETAILED DESCRIPTION

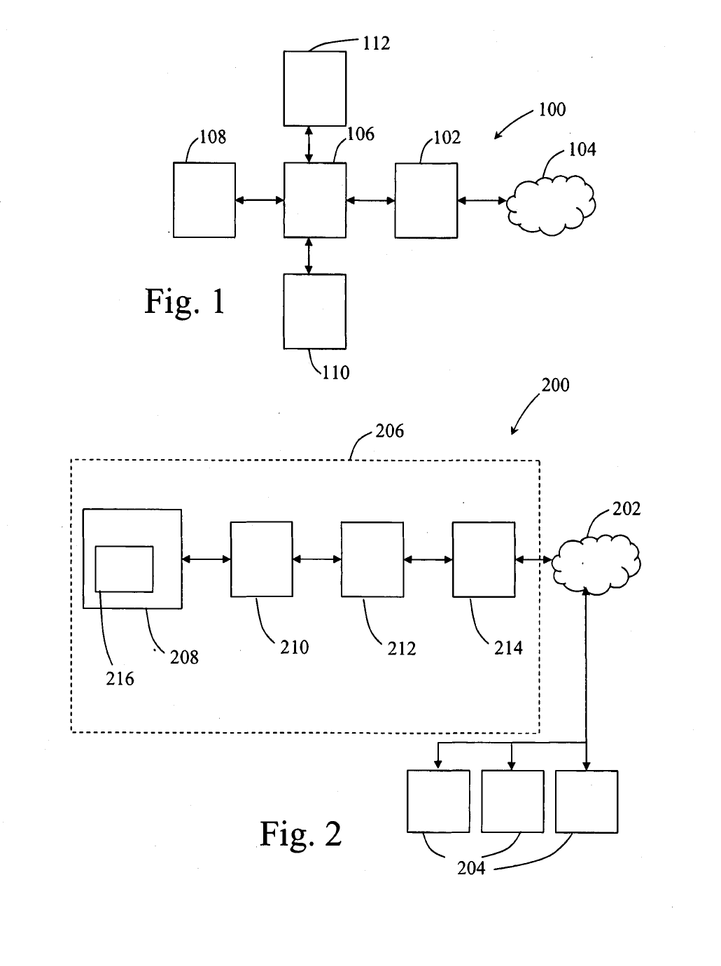

FIG. 1 shows an example system 100 for facilitating a meeting. The system 100 comprises an interface 102 that is in communication with a network 104. The interface 102 is arranged to receive meeting outline information via the network 104. The meeting outline information is in respect of a meeting and includes at least one agenda item. The meeting outline information is typically provided by a meeting participant, a meeting facilitator, or the like. The meeting outline information also typically comprises a list of meeting participants that are to be invited to the meeting, and time and location information indicative of when and where the meeting is scheduled to take place.

The interface 102 is in communication with a database 106, at which the received meeting outline information is stored.

The system 100 also comprises a meeting structure generator 108. The meeting structure generator 108 is arranged to access the meeting outline information stored in the database 106 and to generate a meeting structure based on the received meeting outline information. The generated meeting structure can be communicated to the database 106 where the meeting structure is stored.

The system 100 is also arranged to generate a meeting request at a meeting request generator 110, the meeting request being communicated to each meeting participant via the network 104. The meeting request in this example includes the generated meeting structure, which is obtained from the database 106, including the time and location information.

Meeting participants are able to respond to the meeting request by accepting or declining the meeting request. The database 106 stores the received response of each participant and updates information contained in the database 106 to reflect which participants will be attending the meeting.

When the meeting begins, the system 100 is arranged to communicate the generated meeting structure stored in the database 106 to a meeting participant, such as a meeting facilitator. The meeting facilitator can use the meeting structure to conduct the meeting.

During the meeting, the meeting facilitator or other meeting participant can input additional meeting information, such as agenda outcome information related to an outcome of an agenda item. The agenda outcome information is received by the system 100 via the interface 102 and stored in the database 106.

At the conclusion of the meeting, a meeting report generator 112 accesses information associated with the meeting, including any agenda outcome information, stored in the database 106 and generates a meeting report. The meeting report is stored in the database 106, and is communicated to the meeting participants via the network 104.

FIG. 2 shows another example system 200 for facilitating a meeting. In this example, components of system 100 are implemented as software modules.

The system 200 is accessible via a network 202 such as the Internet, and is arranged to facilitate network communications with the system 200 from a remote location via computing devices 204 or similar. In this example, the remote computing devices 204 are associated with users of the system 200, such as an organiser or facilitator of the meeting, and potential meeting participants. The computing devices 204 may be any appropriate computing device, such as a personal computer, a tablet computer, a mobile phone or a PDA.

In this example, the system 200 comprises a computing device 206, for example a personal computer, in communication with the network 202. The computing device 206 comprises a memory 208 arranged to store programs that may be used by the system 200. The memory 208 may also be used for storing information related to one or more meetings facilitated by the system 200. The stored programs and meeting information are usable by a processor 210 to control and coordinate system operations.

The processor 210 is in communication with a web server 212, which is in communication with the network 202 via a network interface 214. In this way, the system 200 can be accessed by the computing devices 204.

The memory 208 comprises a database 216 for storing the meeting information. The database 216 may be an SQL type database, and the computing device 206 may be provided with appropriate database management software.

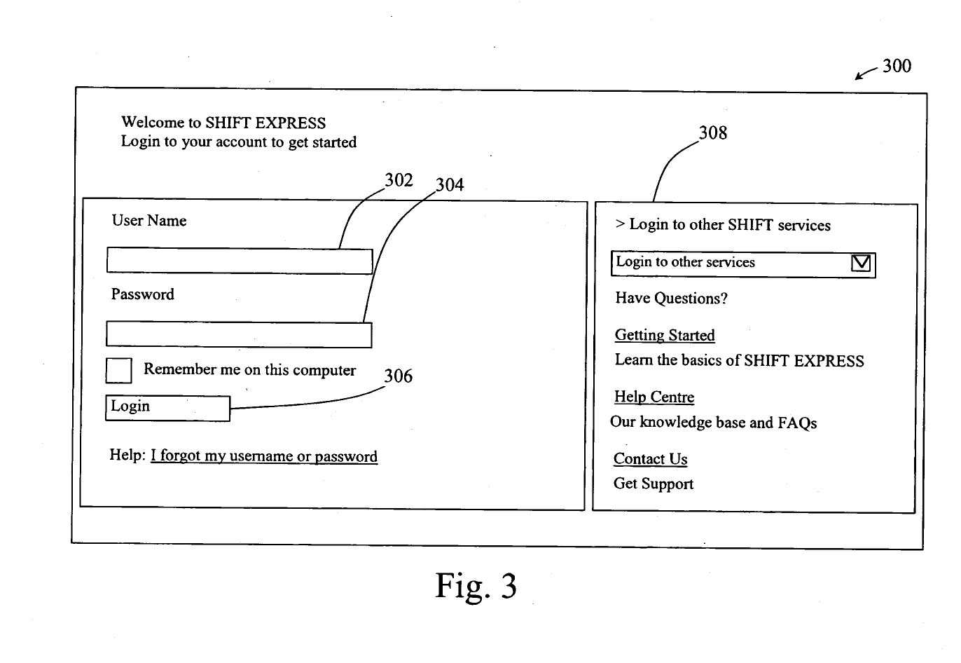

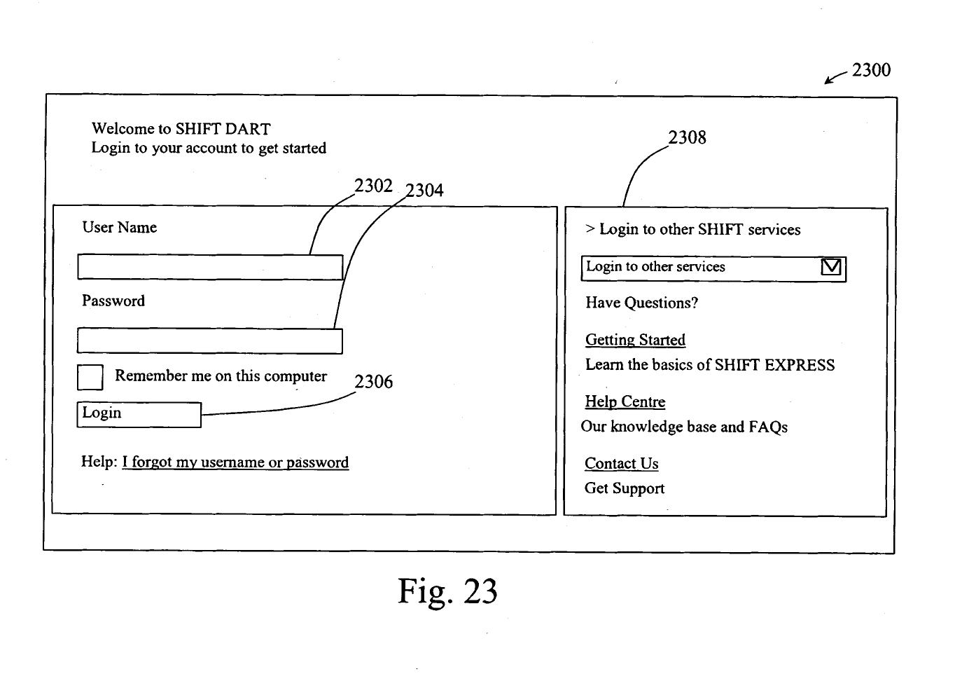

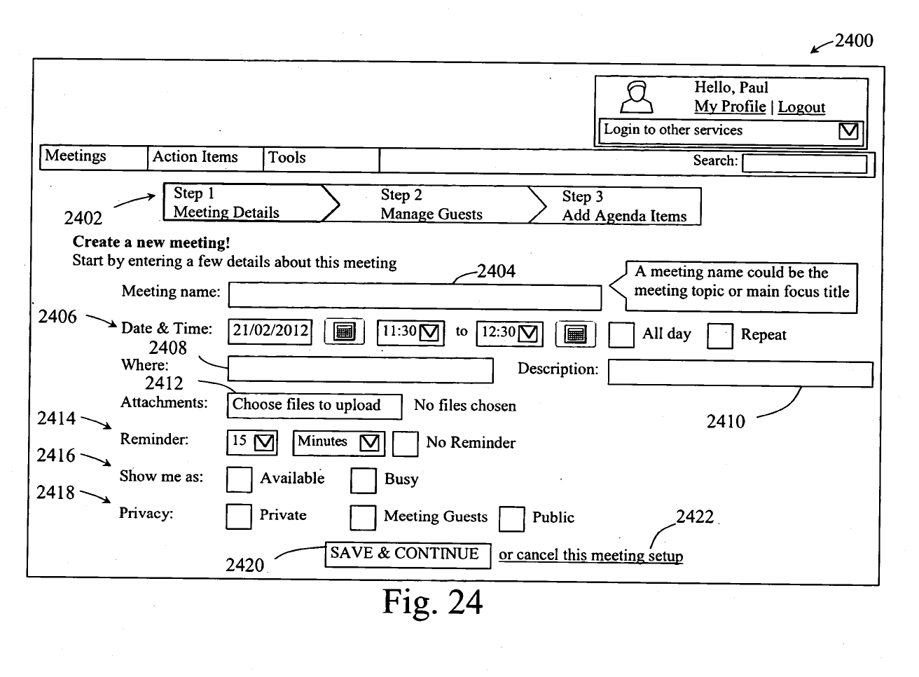

Example screen shots generated by the system 200 will now be described with reference to FIGS. 3 to 22. In this example, the system 200 is arranged to facilitate a strategic-type meeting, and assists in progressing meeting participants through a series of meeting stages. The meeting stages in this example are referred to by the acronym SHIFT, referring to the following progressive meeting stages: Starting ideas, Hindsight, Insight, Foresight and Traction. It will be appreciated that this is only one example of a potential series of meeting stages, and the SHIFT meeting stages can be used in conjunction with other meeting stages and/or only a portion or portions of the SHIFT meetings stages can be used. The system 200 can be arranged to facilitate other types of meetings, and alternative meeting stages are described later with reference to FIGS. 23 to 35.

In general, the system 200 is arranged to enable users of the system to set up user accounts, and to store user information in the database 216 associated with each user account. Users of the system are then able to log in to the system 200 via a web portal on the user's respective computing device 204.

FIG. 3 shows an example log in page 300. The log in page 300 comprises a user name field 302 and a password field 304. A user can log in to the system 200 by entering an appropriate user name and password into the respective fields 302, 304 and clicking on a ‘login’ button 306. The user can access other features of the system 200 via box 308. In this example, the box 308 includes links to other web pages served by the system 200, such as help, FAQ and contact web pages.

After the user has logged in to the system 200, the user will be presented with a welcome page 400. The welcome screen comprises a ‘meetings’ tab 402, an ‘action items’ tab 404 and a ‘tools’ tab 406.

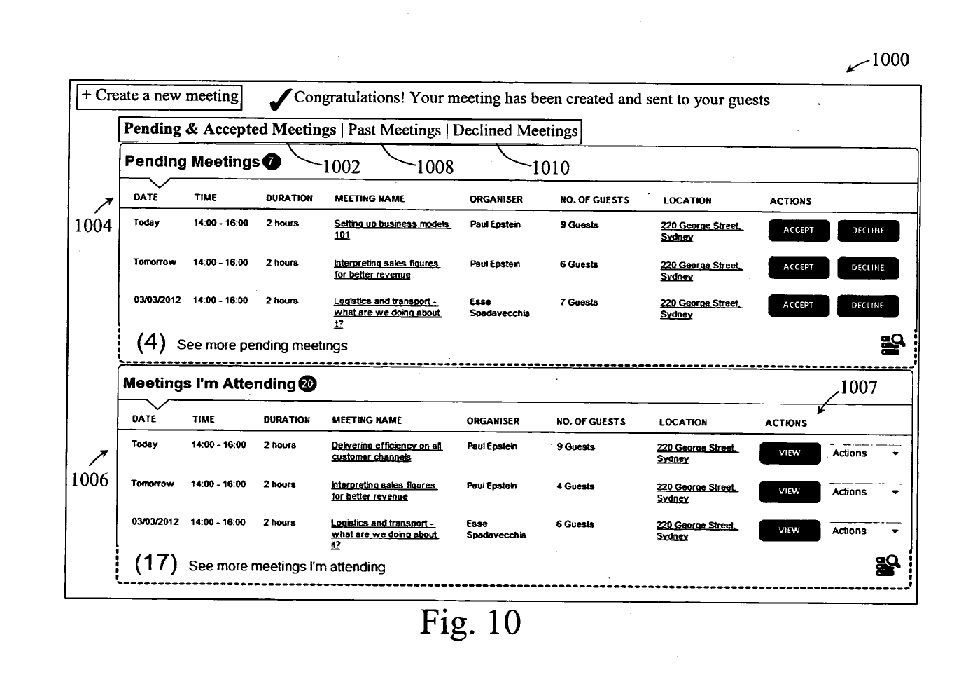

Selecting the ‘meetings’ tab 402 will take the user to a meetings page 1000, which provides an overview of meetings associated with the user as described in more detail later with reference to FIG. 10.

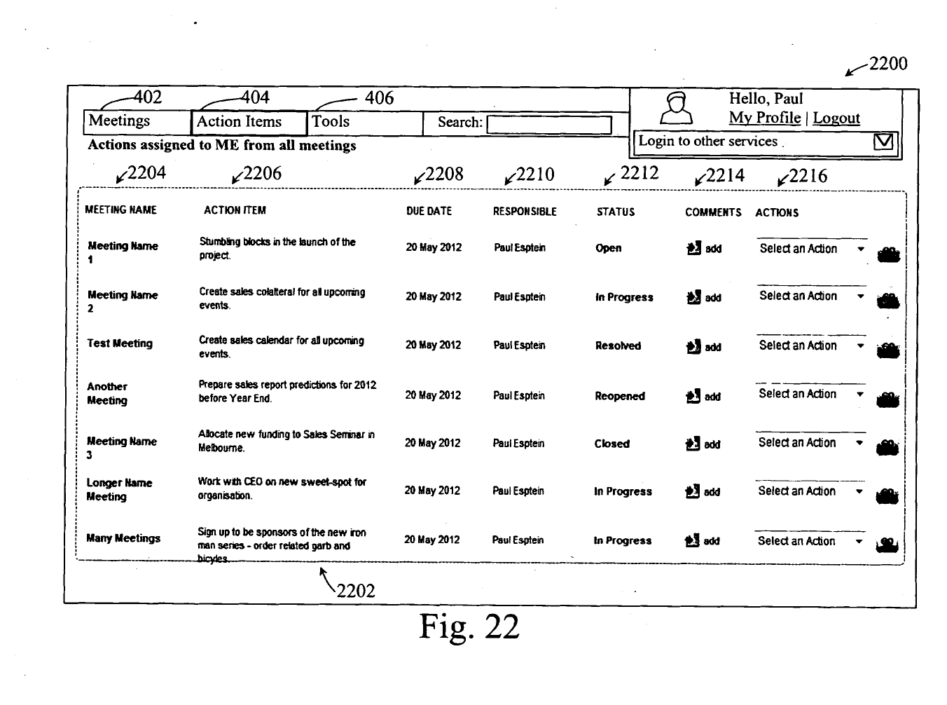

Selecting the ‘action items’ tab 404 will take the user to an action items page 2200. The action items page 2200 provides an overview of action items that have been assigned to the user, and is described in more detail later with reference to FIG. 22.

Selecting the ‘tools’ tab 406 will take the user to a tools page (not shown) which will provide the user with appropriate tools that can be used to customise settings associated with the system 200.

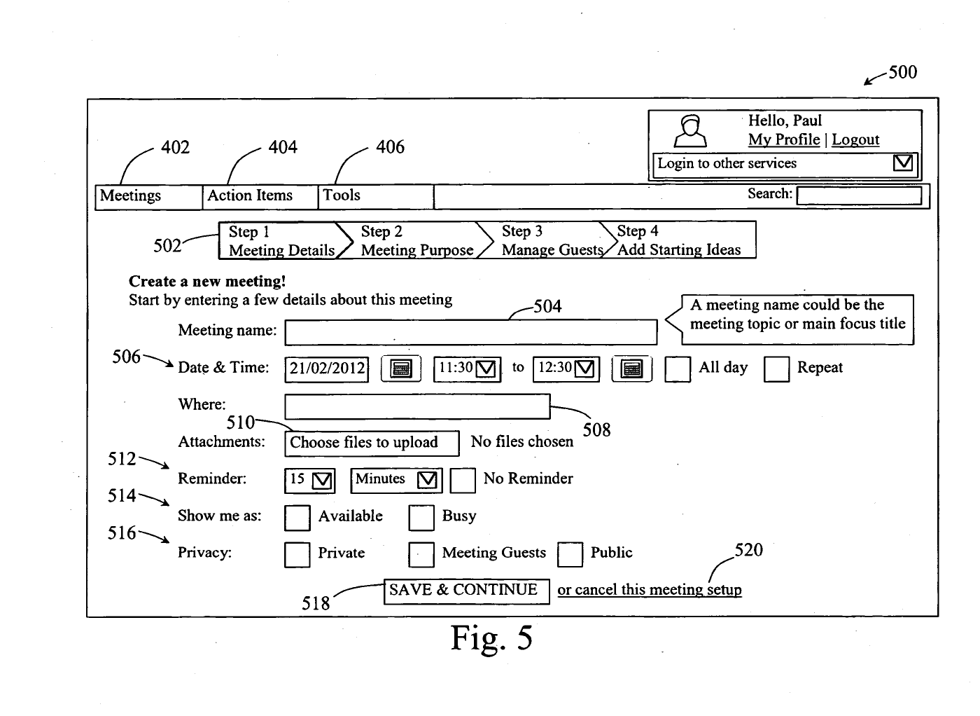

The user is also presented with a ‘create a meeting’ button 408, selection of which will take the user to a ‘meeting details’ page 500 which is described in more detail with reference to FIG. 5. The ‘meeting details’ page 500 facilitates the user entering information as a first step in creating a new meeting.

Selecting a ‘manage guests’ button 410 will take the user to a guest set up page (not shown). The guest set up page can be used to enter new guests (that is, meeting participants) and to manage details associated with the guests. Typically, guests who are entered in the guest set up page are available for selecting to attend a meeting.

The user is also able to select a ‘set up categories & lists’ button 412, which will take the user to a categories and lists set up page (not shown). The categories and lists set up page facilitates categorising meetings and the like. This can facilitate the searching of meetings associated with the user, which can assist in reusing meetings and/or obtaining information in respect of meetings.

As discussed earlier, the user is taken to the meeting details page 500 after selecting the ‘create a meeting’ button 408. The ‘meeting details’ page 500 comprises a progress indicator 502 which indicates a stage that the user is at in creating a new meeting. The progress indicator 502 indicates that the user is at ‘Step 1: Meeting Details’.

The user can enter a name of the meeting in a ‘meeting name’ field 504, and a date and time for the meeting in date and time field 506, and can set the meeting as an all day event or a recurring meeting by checking the ‘all day’ and ‘repeat’ boxes respectively. A location of the meeting is entered in a ‘where’ field 508.

The user is also able to upload one or more documents that are relevant to the meeting by selecting an ‘attachments’ button 510. This will enable the user to navigate to a location of a desired document that can then be selected for upload.

The user can set a time for a reminder to be sent to meeting participants via a ‘reminder’ field 512. The user can also select radio buttons 514 to show the user as ‘busy’ or ‘available’ during the meeting. Further, privacy radio buttons 516 can be selected to set whether meeting details are ‘private’, available to ‘meeting guests’ (that is, meeting participants) or available to the ‘public’.

When the user has completed setting the meeting details, the user can select a ‘save & continue’ button 518 to be taken to a ‘meeting purpose’ page 600. Alternatively, the user can cancel the created meeting by selecting a ‘cancel’ option 520.

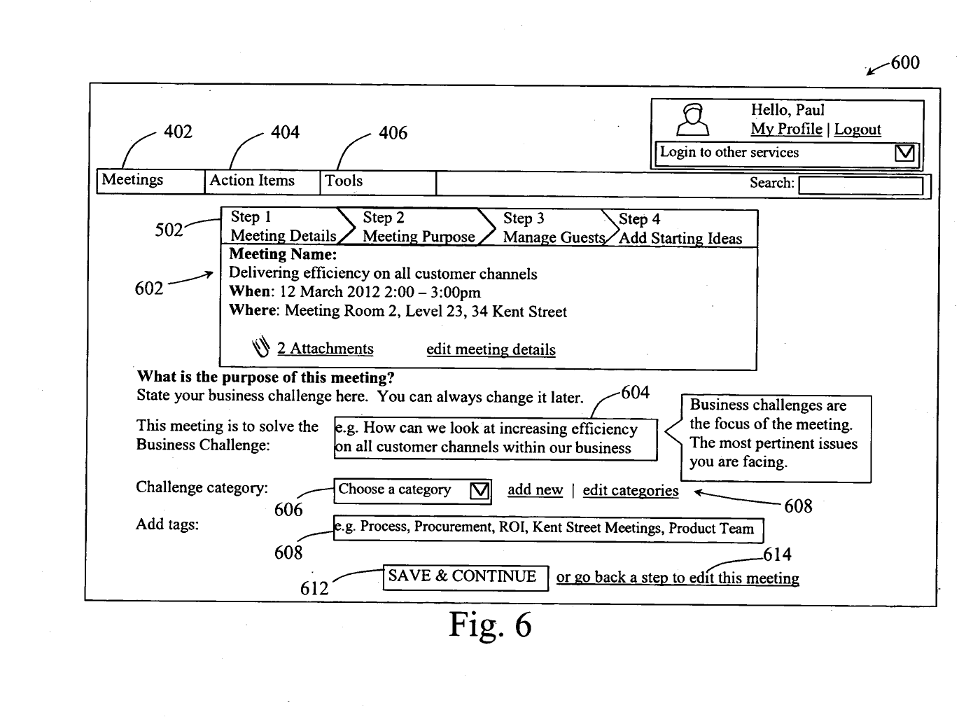

If the user selects the ‘save & continue’ button 518, the user is presented with the ‘meeting purpose’ page 600, as shown in FIG. 6, where the progress indicator 502 indicates that the user is at ‘Step 2: Meeting Purpose’. Meeting detail information 602 is also displayed, summarising details entered on the ‘meeting details’ page 500.

The user is able to enter information regarding a purpose of the meeting in a meeting purpose field 604. The user can also associate the meeting with a category by selecting from a category drop down menu 606. If the user is unable to locate an appropriate category, the user can add a new category or edit an existing category with ‘add new’ and ‘edit categories’ options 608. The user is also able to associate a tag with the meeting via an ‘add tags’ field 610.

Upon completion of the ‘meeting purpose’ page 600, the user can select a ‘save & continue’ button 612 to be taken to a ‘manage guests’ page 700. Alternatively, the user can return to the ‘meeting details’ page 500 by selecting a ‘return’ option 614.

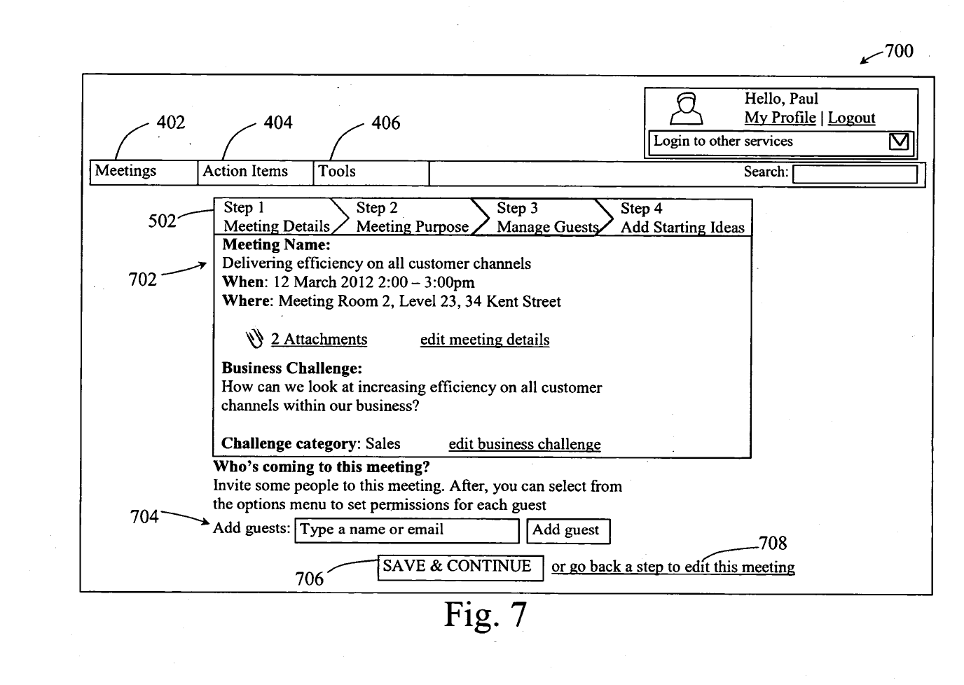

As shown in FIG. 7, the progress indicator 502 of the ‘manage guests’ page 700 indicates that the user is at ‘Step 3: Manage Guests’. Meeting detail information 702 summarises information entered in the previous pages 500, 600 and enables the user to select meeting participants for inviting to the meeting by entering a meeting participant's name or email address into an ‘add guests’ field 704.

After entering the desired meeting participants via the ‘manage guests’ page 700, the user can select a ‘save & continue’ button 706 to be taken to an ‘add starting ideas’ page 800. Alternatively, the user can return to the ‘meeting purpose’ page 600 by selecting a ‘return’ option 708.

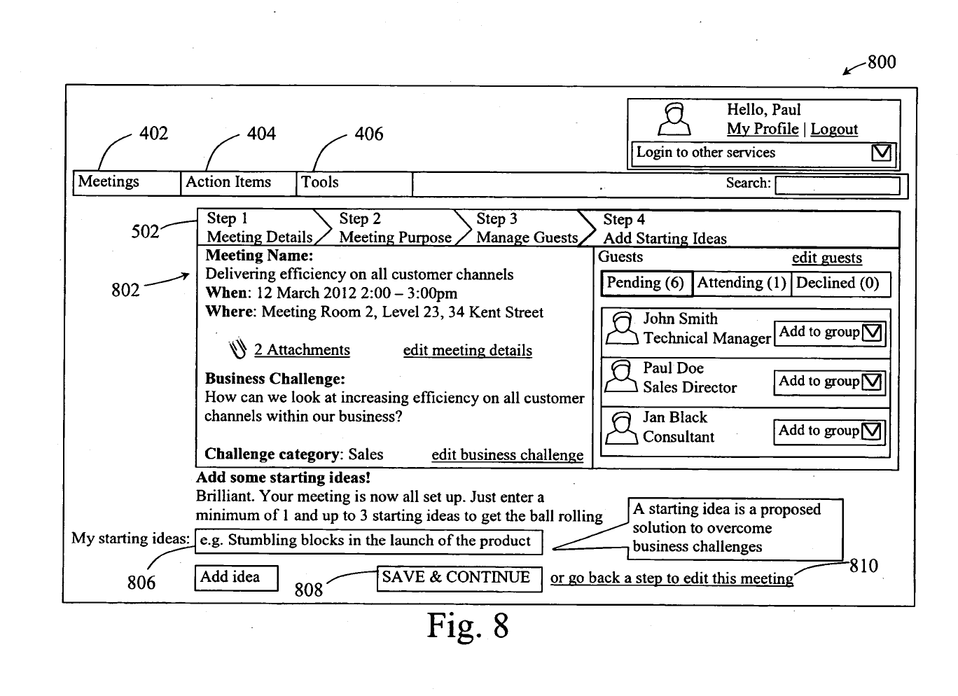

The ‘add starting ideas’ page 800 of FIG. 8 shows, via the progress indicator 502, that the user is at ‘Step 4: Add Starting Ideas’. Meeting detail information 802 has been updated to show meeting participant information 804, including an indication as to which meeting participants have a ‘pending’ meeting request, have ‘accepted’ the meeting request, or have ‘declined’ the meeting request.

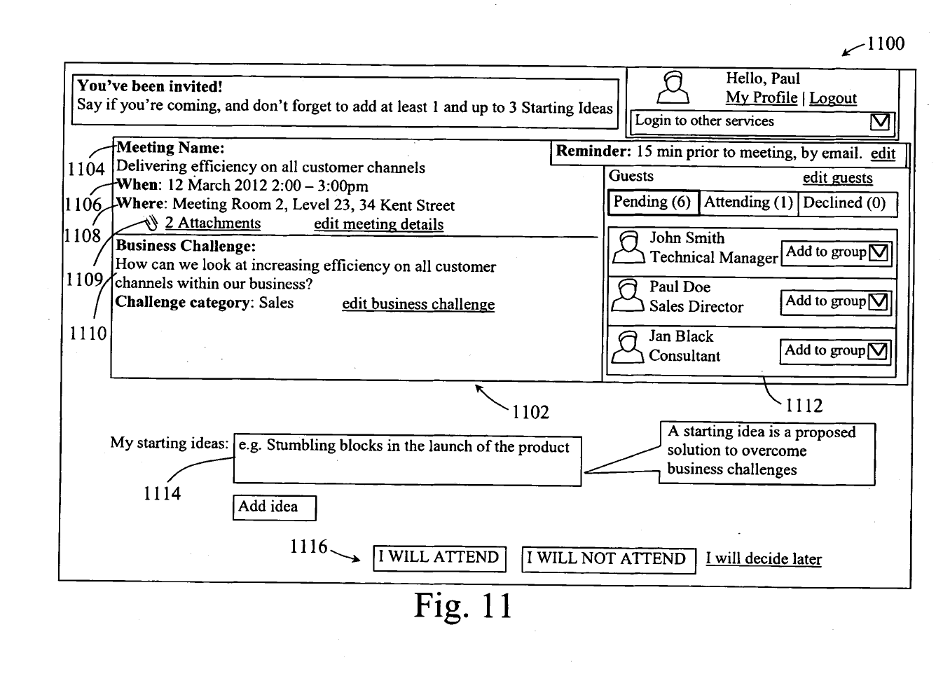

The user is able to enter one or more starting ideas for discussion in the meeting into a ‘my starting ideas’ field 806. Starting ideas are typically proposed solutions to overcome business challenges. Other users who are invited to the meeting are also able to enter starting ideas, as described later in more detail with reference to FIG. 11.

After entering desired starting ideas, the user can select a ‘save & continue’ button 808 to be taken to a ‘send invitation’ page 900. Alternatively, the user can return to the ‘manage guests’ page 700 by selecting a ‘return’ option 810.

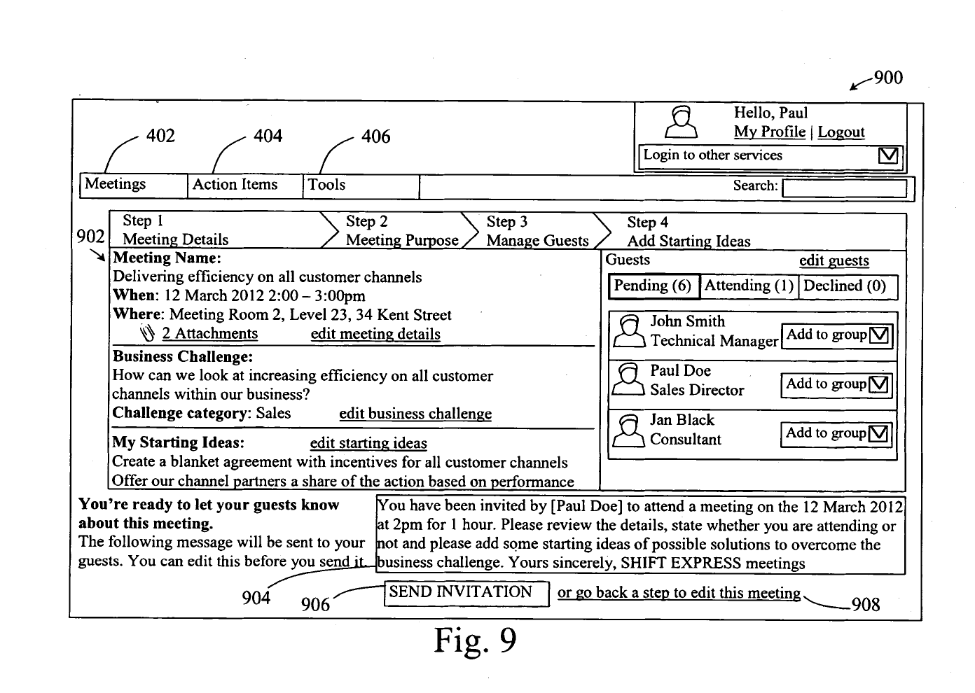

FIG. 9 shows the ‘send invitation’ page 900, where meeting detail information 902 has been updated to reflect information entered in the previous pages. The user is able to edit invitation information at an invitation information field 904, and can then send a meeting request to meeting participants by selecting a ‘send invitation’ button 906. Alternatively, the user can return to the ‘add starting ideas’ page 800 by selecting a ‘return’ option 908.

After sending the meeting request, the user is taken to the meetings page 1000 (see FIG. 10). The meetings page 1000 comprises a ‘pending and accepted meetings’ tab 1002, selection of which presents a summary of meetings that the user has been invited to and that require the user to ‘accept’ or ‘decline’ by selecting the appropriate button (pending meetings box 1004), and upcoming meetings that the user has accepted (accepted meetings box 1006).

The accepted meetings box 1006 also comprises a drop down actions box 1007 for each upcoming meeting. The user is able to select actions to be performed using the drop down actions box 1007. In one example, the user is able to select the following actions from the drop down actions box 1007: start meeting, add starting idea, resend invitation, duplicate meeting, print meeting, decline meeting, delete meeting.

The user is also able to select a ‘past meetings’ tab 1008 to view details of past meetings, and to select a ‘declined meetings’ tab 1010 to view details of meetings that the user has declined. Providing the user with access to details of past meetings can assist the user in following up on action items, for example.

If the user wishes to create a new meeting, the user is able to select a ‘create new meeting’ icon 1012, which will take the user to the ‘meeting details’ page 500.

If the user selects a meeting from the ‘pending meetings’ box 1004, the user is taken to a ‘pending meeting’ page 1100 as shown in FIG. 11. The ‘pending meeting’ page 1100 presents the user with details of the meeting to which the user has been invited in a meetings details box 1102. The meeting details box 1102 will present the user with a meeting name 1104, a meeting time 1106, a meeting location 1108, a link to meeting attachments 1109, a meeting purpose 1110 and a guest list 1112. In this example, the guest list 1112 indicates which guests are yet to accept or decline the meeting invitation, which guests are attending, and which guests have declined the meeting invitation.

The ‘pending meeting’ page 1100 also comprises a ‘starting ideas’ field 114, in which the user can add one or more starting ideas that may be relevant to the meeting purpose 1110. It will be appreciated that each user can enter one or more starting ideas, and the system 200 is arranged to receive entered starting ideas from each user for inclusion in the meeting structure.

The user is also able to ‘accept’, ‘decline’ or defer a decision to accept or decline by electing an option from ‘meeting attendance’ buttons 1116.

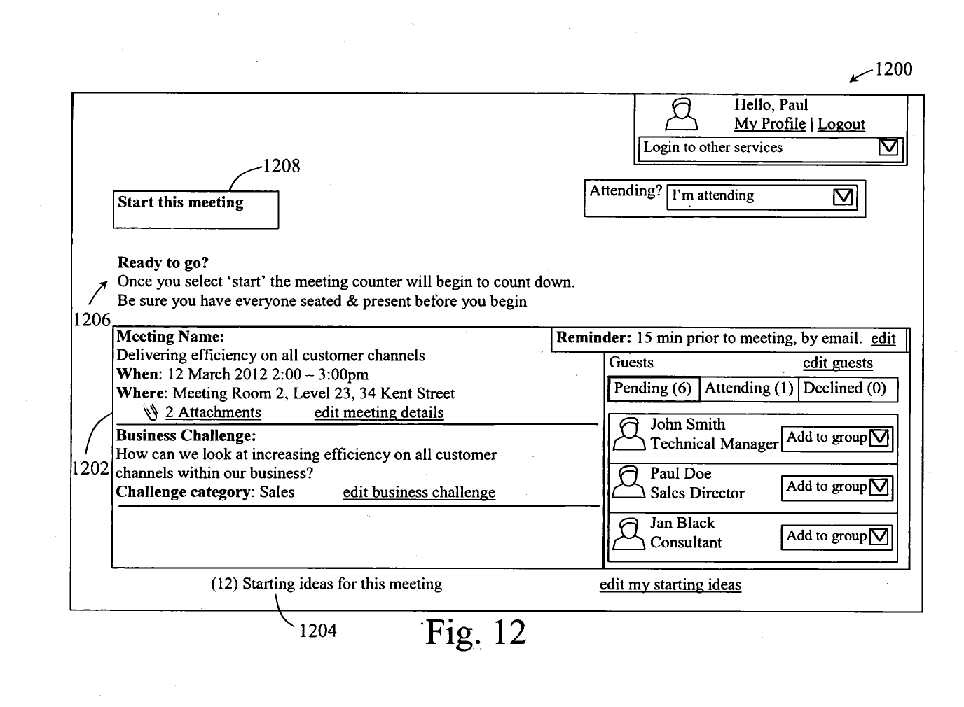

When the meeting is ready to take place, the user, who may be a facilitator of the meeting, is presented with a ‘start meeting’ page 1200 (see FIG. 12) comprising a meeting details box 1202 that presents the user with relevant meeting details. The meeting details box 1202 also comprises starting ideas 1204, corresponding to starting ideas that were entered when the meeting was created and/or by meeting participants from their respective ‘pending meeting’ page 1100.

The ‘start meeting’ page 1200 also comprises meeting guidance information 1206 that facilitates the user in running the meeting. In this example, the meeting guidance information has been generated by the system 200, and reminds the user to ensure that meeting participants are seated and present before beginning the meeting. It will be appreciated that the meeting may be virtual, in which case the meeting guidance information may remind the user to begin the meeting when meeting participants have logged into the virtual meeting room.

The user is able to begin the meeting by selecting a ‘start this meeting’ button 1208.

Once the meeting has begun, the system 200 presents the user with a structured series of pages to assist the user in facilitating the meeting. The system 200 allocates time periods for different stages of the meeting and prompts the user with a sequence of steps to take for each stage of the meeting. The system 200 also enables the user to enter information gathered from the meeting, such as further ideas or outcomes that arise from the meeting.

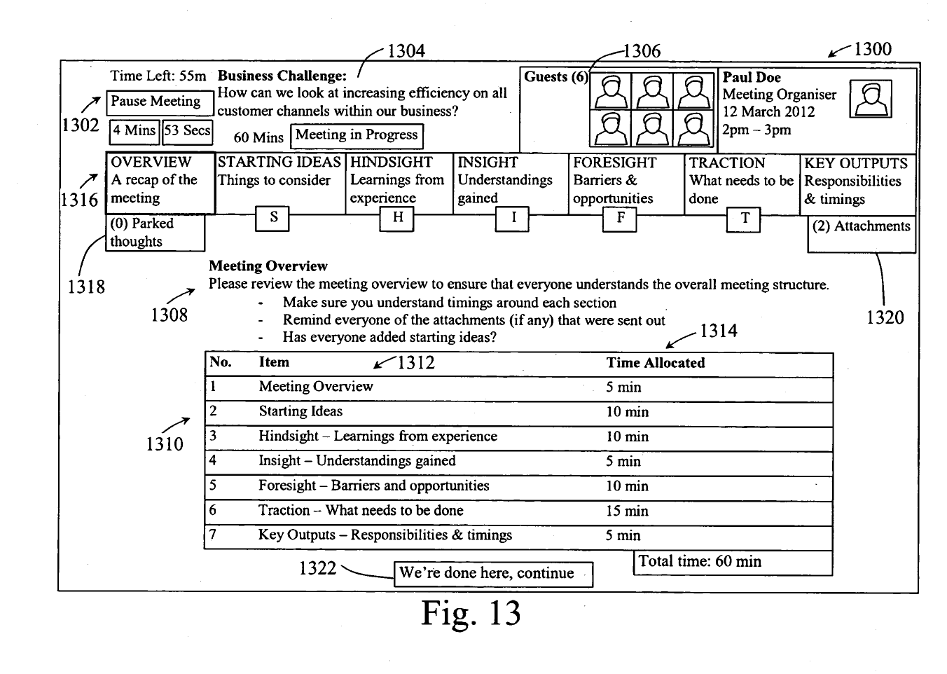

In a first stage of the meeting, the system 200 presents the user with a ‘meeting overview’ page 1300 as shown in FIG. 13. The meeting overview page 1300 comprises time information 1302 which indicates time remaining in the meeting, and time remaining for a current meeting stage. In this example, the meeting stage is an ‘overview’ stage, and the time information 1302 indicates that there are 55 minutes left in the meeting, and 4 minutes and 53 seconds remaining to complete the ‘overview’ stage of the meeting. The system 200 is arranged to alert the user if the ‘overview’ stage of the meeting exceeds the time period allocated for the ‘overview’ stage. The system 200 is arranged to provide similar alerts for further meeting stages if the time period of any meeting stage exceeds its respective allocated time period. The system 200 is also arranged to provide an early warning alert prior to the time period being exceeded, for example 2 minutes prior to the time period being exceeded.

It will be appreciated that the system 200 may also be arranged to generate an alert if the total amount of time spent on the meeting exceeds a suggested meeting length time that is provided to the system 200 or generated by the system 200. The system 200 may also generate an early warning alert prior to the suggested meeting time length being exceeded, for example when there are 5 minutes left in the meeting.

The ‘meeting overview’ page 1300 also displays meeting purpose information 1304, which corresponds to the meeting purpose information input to the meeting purpose field 604 of the ‘meeting purpose’ page 600. A list of meeting participants 1306 is also displayed, corresponding to meeting participants who ‘accepted’ the meeting request.

The ‘meeting overview’ page 1300 also comprises meeting overview stage information 1308. The information 1308 is used to prompt the user with steps to facilitate progressing through the ‘meeting overview’ stage. In this example, the information 1308 reminds the user to review the meeting overview to ensure that the meeting participants understand the overall meeting structure. The information 1308 also prompts the user to ensure that the user understands time periods associated with each meeting stage, reminds the meeting participants of any meeting attachments that were associated with the meeting, and to ask if each participant has added at least one starting idea.

The ‘meeting overview’ page 1300 also comprises meeting overview information 1310. The meeting overview information 1310 lists meeting stages 1312 and a time period 1314 associated with each meeting stage 1312 (including a total meeting time at a bottom of the list of time periods 1314).

The ‘meeting overview’ page 1300 also comprises meeting stage progress information 1316, listing an order of meeting stages, and indicating that the meeting is presently at the ‘overview’ stage. The stages identified in the meeting stage progress information 1316 mirror the meeting stages 1312 listed in the meeting overview information 1310. In this example, the meeting stages progress through the following: ‘overview’, ‘starting ideas’, ‘hindsight’, ‘insight’, ‘foresight’, ‘traction’ and ‘key outputs’.

Below the meeting stage progress information 1316 is a ‘parked thoughts’ icon 1318. Throughout the meeting, the user can select the ‘parked thoughts’ icon 1318 to enter any relevant points, issues, thoughts, opinions or the like (parked thoughts') that are raised during the meeting. The user can return to any ‘parked thoughts’ at any time during the meeting by selecting the parked thoughts' icon 1318 for discussion.

Also below the meeting stage progress information 1316 is an ‘attachments’ icon 1320. Selecting the ‘attachments’ icon 1320 will present any attachments that are associated with the meeting. This provides the user with quick access to the relevant meeting attachments.

When the user is ready to progress to the next page, the ‘starting ideas’ page 1400, the user is able to select a next meeting stage button 1322.

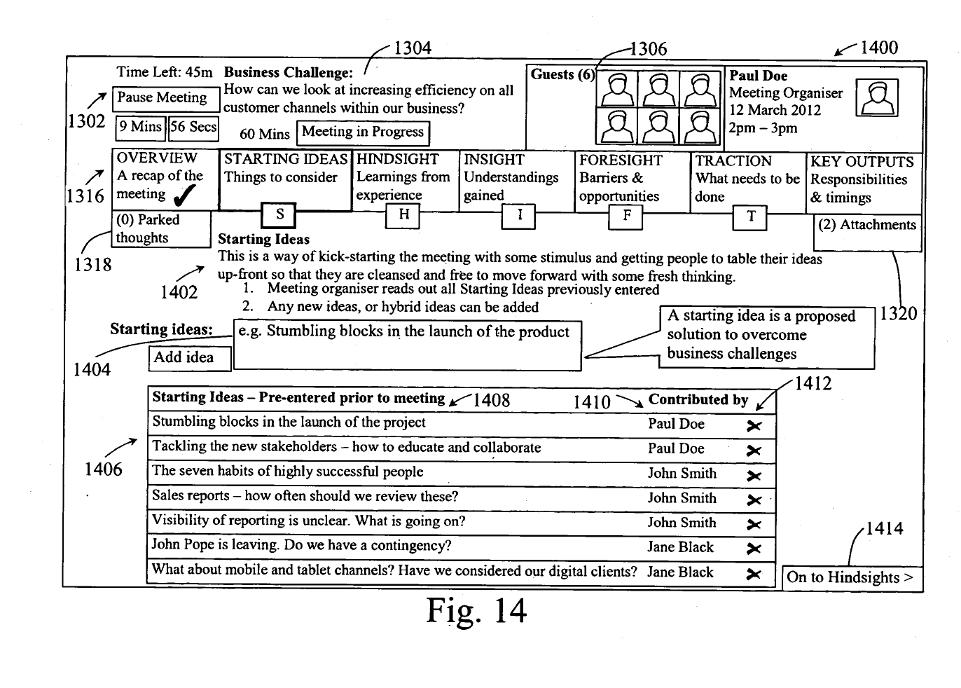

In a second stage of the meeting, the system 200 presents the user with the ‘starting ideas’ page 1400 as shown in FIG. 14. The ‘starting ideas’ page 1400 comprises starting ideas stage information 1402. The information 1402 is used to prompt the user with steps to facilitate progressing through the ‘starting ideas’ stage. In this example, the information 1402 reminds the user that the ‘starting ideas’ stage is to start the meeting with some stimulus, and to get meeting participants to table their ideas up-front.

The information 1402 also prompts the user to read out all starting ideas that have been associated with the meeting, and to add any new ideas or hybrid ideas that are raised during the ‘starting ideas’ stage. If new ideas and/or hybrid ideas are raised, they can be entered into a ‘starting ideas’ field 1404.

The ‘starting ideas’ page 1400 also comprises ‘starting ideas’ information 1406, listing starting ideas 1408, a contributor associated with each starting idea 1410, and a check item 1412 to indicate that each starting idea 1408 has been discussed. The listed starting ideas 1408 correspond to starting ideas that have been entered into the system 200 during creation of the meeting, by meeting participants when accepting the meeting request, and any new and/or hybrid ideas that were entered in to the ‘starting ideas’ field 1404.

The ‘starting ideas’ page 1400 also comprises a next meeting stage button 1414, selection of which will take the user to a ‘hindsight’ page 1500.

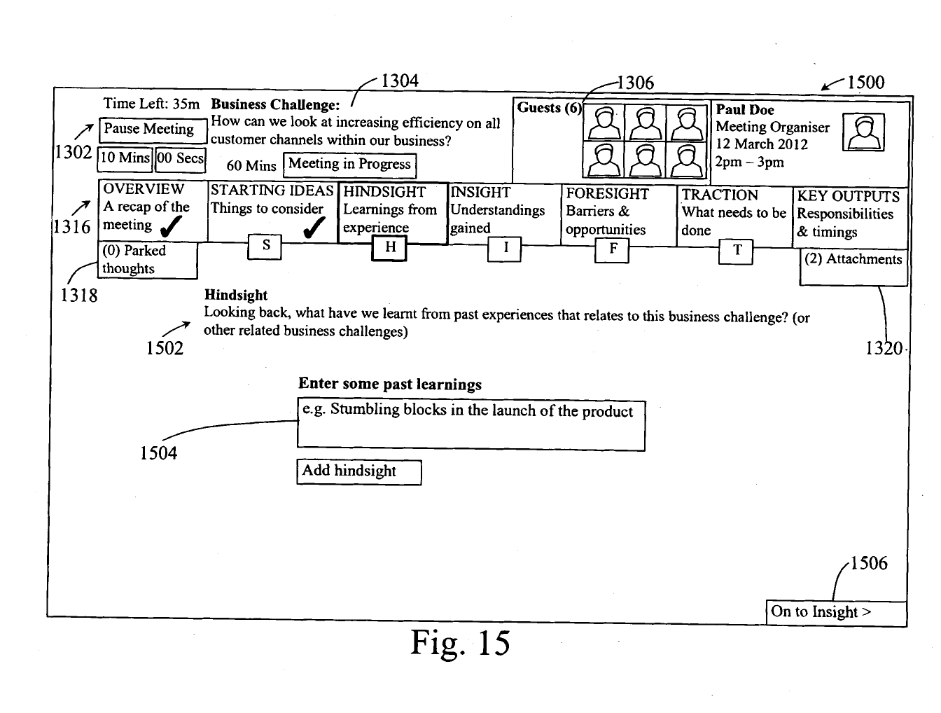

In a third stage of the meeting, the system 200 presents the user with the ‘hindsight’ page 1500 as shown in FIG. 15. The ‘hindsight’ page 1500 comprises hindsight stage information 1502. The information 1502 is used to prompt the user with steps to facilitate progressing through the ‘hindsight’ stage. In this example, the information 1502 prompts the user with a question relating to what has been learned in the past with respect to the meeting purpose topic.

The user can ask the meeting participants for responses to this question, and the user can enter information associated with such responses into a ‘hindsight’ field 1504.

Once completed, the user can select a next meeting stage button 1506 to progress to an ‘insight’ page 1600.

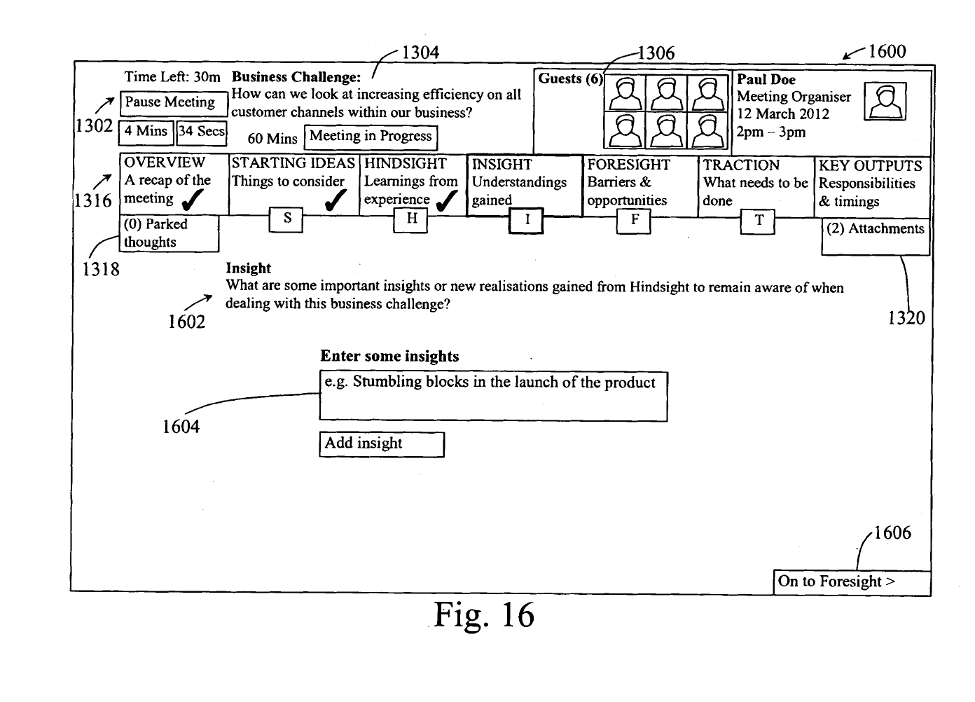

In a fourth stage of the meeting, the system 200 presents the user with the ‘insight’ page 1600 as shown in FIG. 16. The ‘insight’ page 1600 comprises insight stage information 1602. The information 1602 is used to prompt the user with steps to facilitate progressing through the ‘insight’ stage. In this example, the information 1602 prompts the user with a question relating to what some important insights or new realisations are that were gained from the ‘hindsight’ stage, and that the meeting participants should remain aware of when dealing with the meeting purpose topic.

The user can ask the meeting participants for responses to this question, and the user can enter information associated with such responses into an ‘insight’ field 1604.

Once completed, the user can select a next meeting stage button 1606 to progress to a ‘foresight’ page 1700.

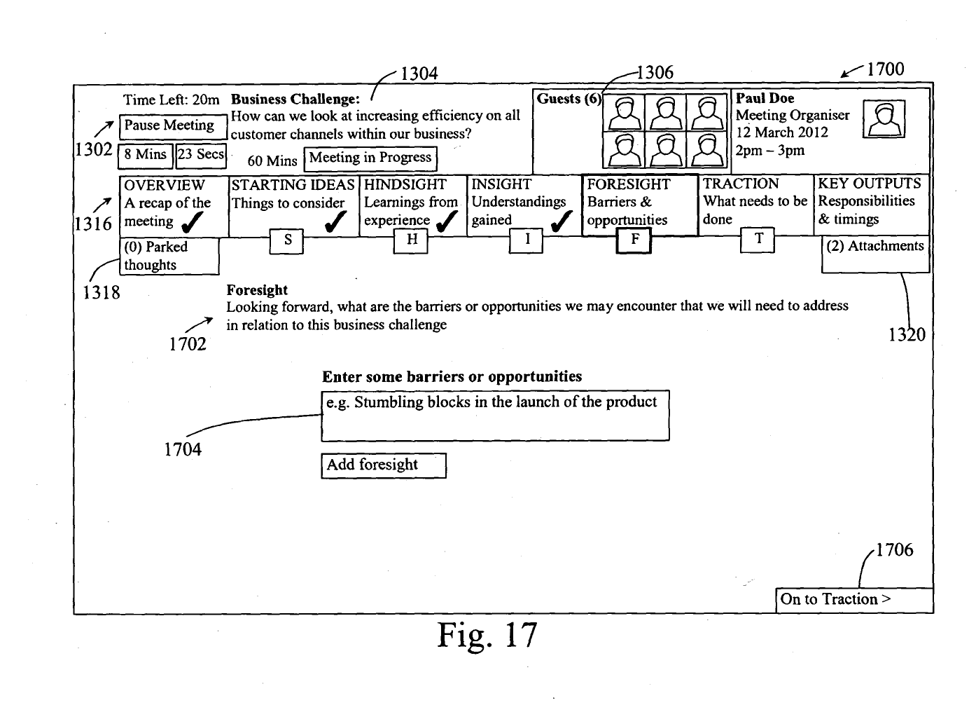

In a fifth stage of the meeting, the system 200 presents the user with the ‘foresight’ page 1700 as shown in FIG. 17. The ‘foresight’ page 1700 comprises foresight stage information 1702. The information 1702 is used to prompt the user with steps to facilitate progressing through the ‘foresight’ stage. In this example, the information 1702 prompts the user with a question relating to what barriers or opportunities may be encountered in the future that will need to be addressed with respect to the meeting topic.

The user can ask the meeting participants for responses to this question, and the user can enter information associated with such responses into a ‘foresight’ field 1704.

Once completed, the user can select a next meeting stage button 1706 to progress to a ‘traction’ page 1800.

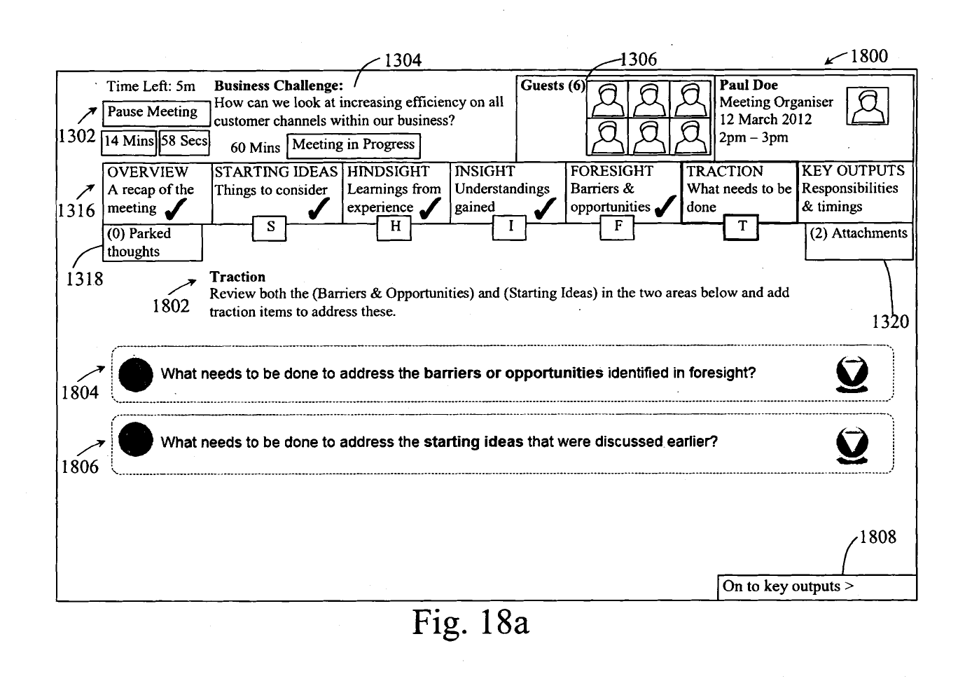

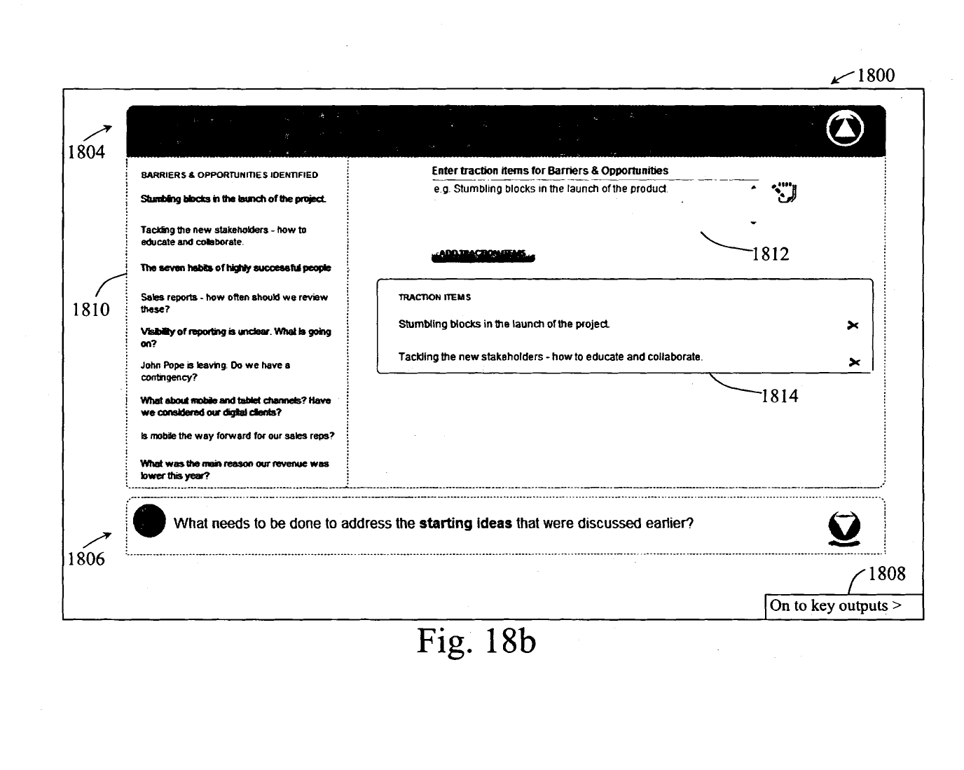

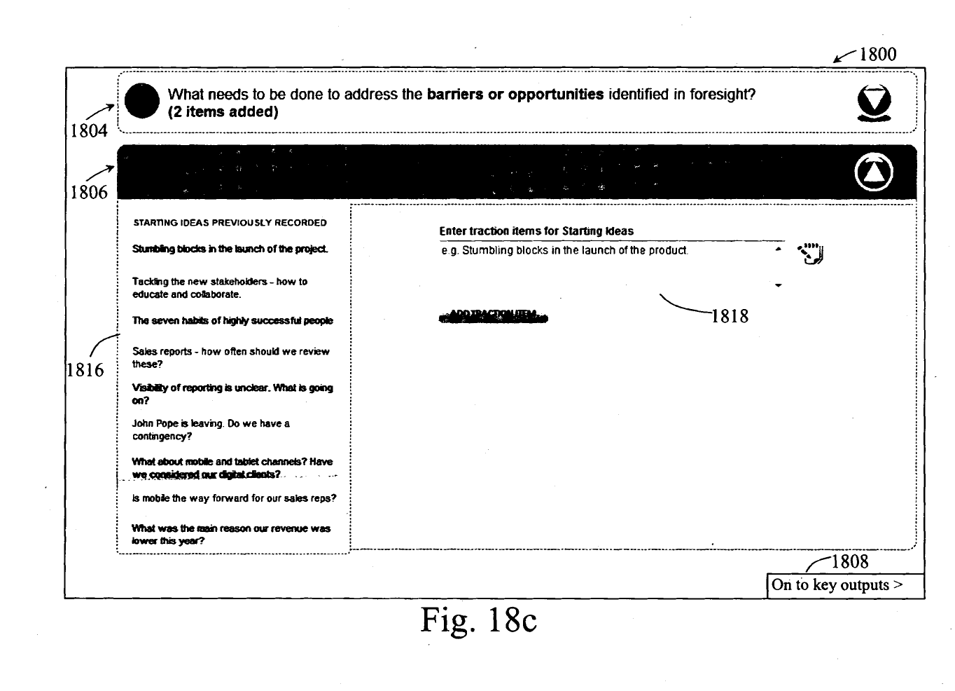

In a sixth stage of the meeting, the system 200 presents the user with the ‘traction’ page 1800 as shown in FIGS. 18a to 18c. The ‘traction’ page 1800 comprises traction stage information 1802 that is used to prompt the user with steps to facilitate progressing through the ‘traction’ stage. In this example, the information 1802 prompts the user to review information that was entered into the ‘foresight’ field 1704 (so-called ‘barriers and opportunities’) and starting ideas that were listed in the ‘starting ideas’ information 1406.

To facilitate this, the ‘traction’ page 1800 comprises a ‘barriers or opportunities’ traction box 1804 for entering information associated with what needs to be done to address barriers or opportunities that were raised during the foresight stage. The box 1804 is expandable to reveal further details (see FIG. 18b).

The ‘traction’ page 1800 also comprises a ‘starting ideas’ traction box 1806 for entering information associated with what needs to be done to address starting ideas that were raised during the starting ideas stage. The box 1806 is expandable to reveal further details (see FIG. 18c).

The ‘traction’ page 1800 also comprises a next meeting stage button 1808 to enable the user to progress to a ‘key outputs’ page 1900.

Referring to FIG. 18b, the ‘barriers or opportunities’ traction box 1804 comprises a list 1810 of ‘barriers or opportunities’, and a ‘barriers or opportunities’ traction box 1812 for entering information associated with what needs to be done to address the listed barriers or opportunities 1810. Completed entries appear in a ‘barriers or opportunities’ traction list 1812.

Referring to FIG. 18c, the ‘starting ideas’ traction box 1806 comprises a list 1816 of ‘starting ideas’, and a ‘starting ideas’ traction box 1818 for entering information associated with what needs to be done to address the listed starting ideas 1816. Completed entries appear in a ‘starting ideas’ traction list (not shown in this example).

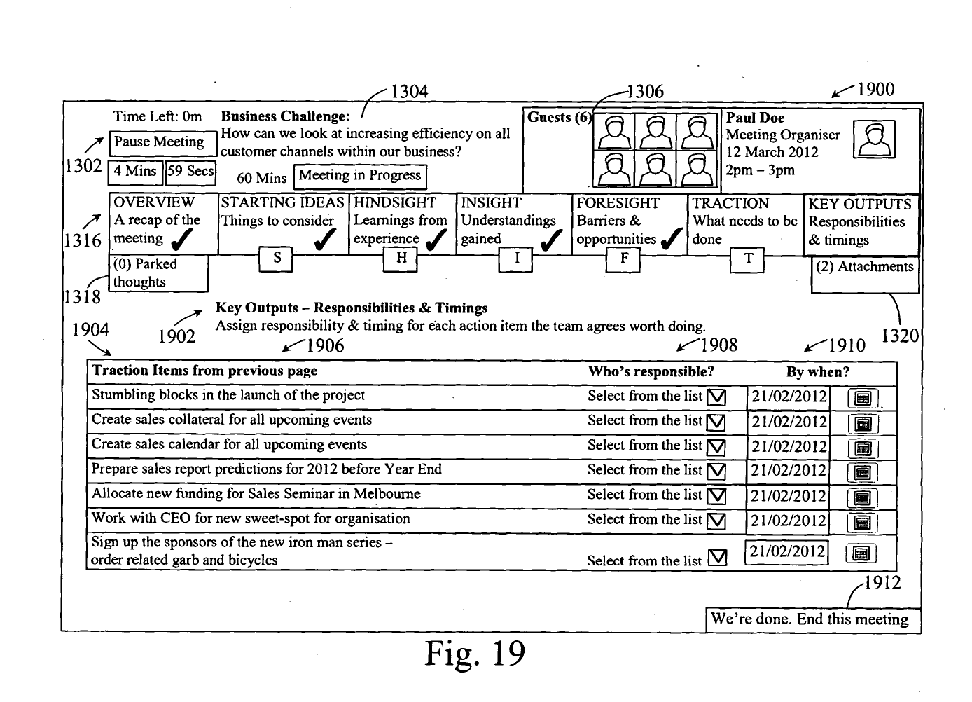

In a seventh stage of the meeting, the system 200 presents the user with the ‘key outputs’ page 1900 as shown in FIG. 19. The ‘key outputs’ page 1900 comprises key outputs stage information 1902 for use in prompting the user through the ‘key outputs’ stage. In this example, the information 1902 prompts the user to assign responsibility and timing for each action item the meeting participants agree are worth completing.

The ‘key outputs’ page 1900 comprises a ‘key outputs’ box 1904 comprising a list of traction items 1906. The user can select a person responsible for each fraction item from a drop down list 1908, and select a date for completion of the required action via a date field 1910.

Once completed, the user can select an end meeting button 1912, which will take the user to a ‘send summary’ page 2000.

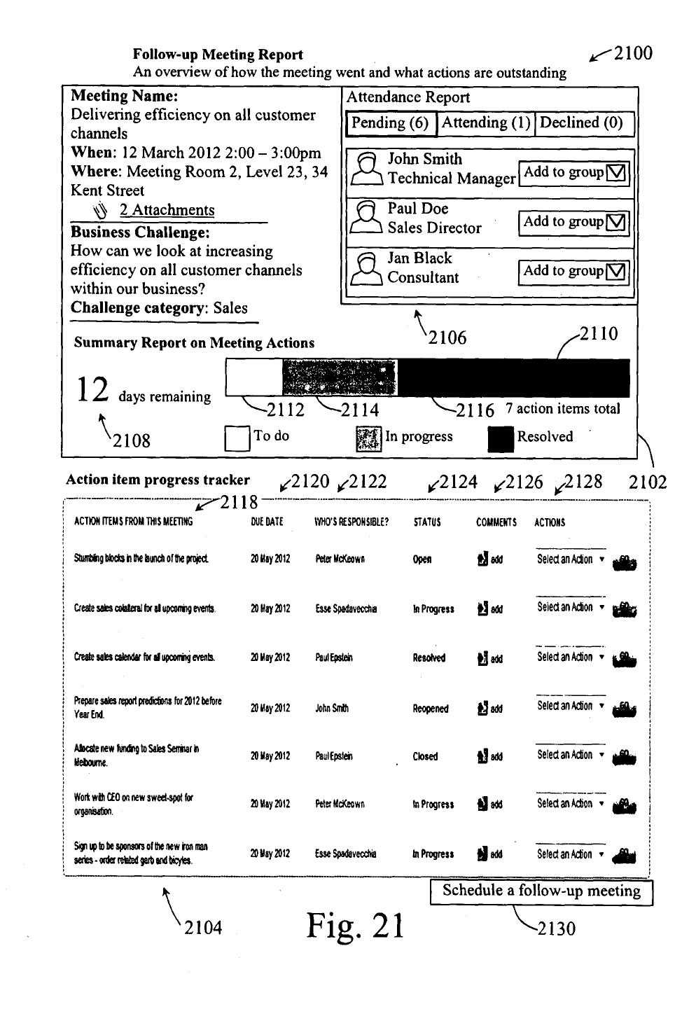

When the meeting has concluded, the system 200 generates a meeting report which can be communicated to the meeting participants or other recipients as desired. The system 200 generates the report based on information entered when the meeting was created, and based on information entered during the meeting. An example meeting report is shown in FIG. 21.

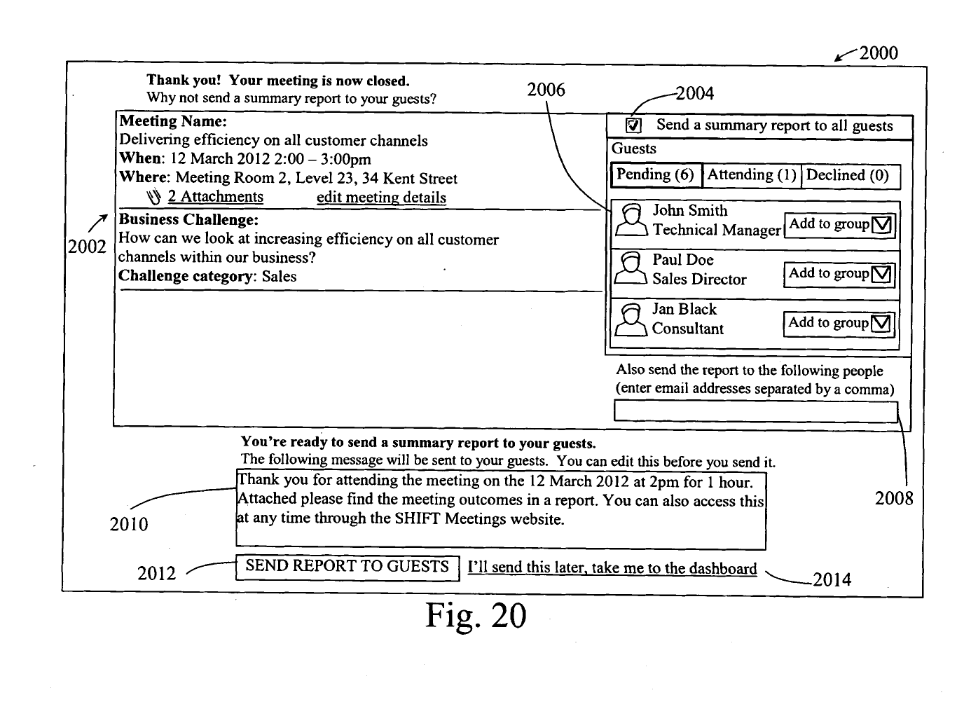

FIG. 20 shows the ‘send summary’ page 2000. The ‘send summary’ page 2000 shows meeting detail information 2002, including a check box 2004 for selecting to send a generated meeting report to the meeting participants shown in meeting participant box 2006. The user is also able to enter additional recipients of the generated meeting report via a recipient field 2008. Prior to sending the generated meeting report, the user can edit meeting summary information at a meeting summary information field 2010, and can then send the meeting report to meeting participants by selecting a ‘send report to guests’ button 2012. Alternatively, the user can return to the ‘welcome’ page 400 by selecting a ‘return’ option 2014.

FIG. 21 shows an example ‘meeting report’ page 2100. The ‘meeting report’ page 2100 provides an overview of how the meeting went and action items that are outstanding from the meeting. In this example, the ‘meeting report’ page 2100 comprises meeting overview information 2102 and action item progress information 2104.

The meeting overview information 2102 comprises meeting details 2106, including information on meeting participant attendance, time information 2108 indicative of an amount of time remaining for action items to be completed, and an action item progress bar 2110. The action item progress bar 2110 indicates what proportion of action items are ‘to do’ 2112, ‘in progress’ 2114 and ‘resolved’ 2116.

The action item progress information 2104 comprises a list of action items 2118. The action items 2118 correspond to the traction items 1906 that were entered at the ‘key outputs’ page 1900. Each action item 2118 has an associated due date 2120, responsible person 2122 and status 2124. The user is also able to associate comments with a respective action item 2118 by selecting from an icon from a ‘comments’ column 2126. The user can select an action from an action drop down box 2128. Selectable actions include, in this example, ‘start action’, ‘resolve action’ and ‘close action’.

The status 2124 of an action item 2118 will be ‘open’ if the person assigned to the action item 2118 has not yet selected an action from the action drop down box 2128. The status 2124 of an action item 2118 will be ‘in progress’ if the person assigned to the action item 2118 has selected ‘start action’ from the action drop down box 2128. The status 2124 of an action item 2118 will be ‘resolved’ if the person assigned to the action item 2118 has selected ‘resolve action’ from the action drop down box 2128. Finally, the status 2124 of an action item 2118 will be ‘closed’ if the person assigned to the action item 2118 has selected ‘close action’ from the action drop down box 2128.

The user can also select ‘assign to me’, ‘reassign’ or ‘send reminder’ from the action drop down box 2128. ‘Assign to me’ will assign the action item 2118 to the user, ‘reassign’ will enable the user to select a different person to assign the action item to 2118, and ‘send reminder’ will cause the system 200 to communicate a reminder regarding the action item 2118 to the relevant responsible person 2122.

The ‘meeting report’ page 2100 also comprises a ‘schedule a follow up meeting’ button 2130, selection of which will take the user to the ‘meeting details’ page 500 to enable the user to schedule a follow up meeting. The system 200 can pre-fill items during meeting creation based on information included in the generated meeting report. For example, the system 200 can enter action items 2118 that have not been resolved or closed as agenda items for the follow up meeting.

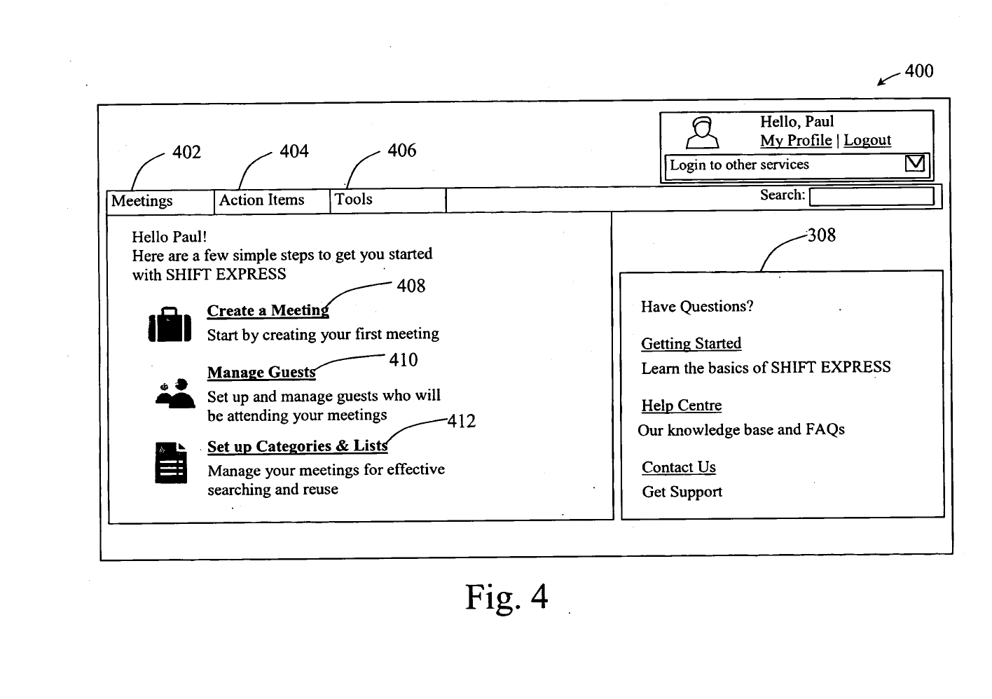

As mentioned earlier with reference to FIG. 4, the user can select an ‘action items’ tab 404 to be taken to the action items page 2200. The action items page 2200 provides overview information 2202 of action items that have been assigned to the user as a result of various meetings. In this example, the overview information 2202 comprises a meeting name column 2204, listing the various meetings that resulted in the user being selected as responsible for respective action items 2206. Each action item 2206 has an associated due date 2208, person responsible 2210 (in this case indicating that the user is the responsible person), status 2212, comment 2214 and action drop down box 2216, functions of which are substantially similar to the corresponding items described with reference to the item progress information 2104 of FIG. 21. In this example, actions that are selectable from the action drop down box 2216 are restricted to ‘start action’, ‘resolve action’, ‘close action’ and ‘reassign’. That is, the user is unable to select the ‘assign to me’ or send reminder’ options as these options are not relevant given that the user is assigned to the listed action items 2206.

Further example screen shots generated by the system 200 will now be described with reference to FIGS. 23 to 35. In this example, the system 200 is arranged to facilitate a typical meeting wherein agenda items are discussed, and facilitates meeting participants to progress through a series of meeting stages. The meeting stages in this example are referred to by the acronym DART, referring to the following progressive meeting stages: Discussion, Action, Responsibility and Timing. It will be appreciated that this is only one example of a potential series of meeting stages, and the DART meeting stages can be used in conjunction with other meeting stages and/or only a portion or portions of the DART meetings stages can be used. It will also be appreciated that a meeting agenda type item using the DART meeting stages can be incorporated into the SHIFT meeting stages and vice versa.

FIG. 23 shows an example log in page 2300. The log in page 2300 comprises a user name field 2302 and a password field 2304. A user can log in to the system 200 by entering an appropriate user name and password into the respective fields 2302, 2304 and clicking on a ‘login’ button 2306. The user can access other features of the system 200 via box 2308. In this example, the box 2308 includes links to other web pages served by the system 200, such as help, FAQ and contact web pages.

After the user has logged in to the system 200, the user will be presented with a meeting details page 2400. The ‘meeting details’ page 2400 comprises a progress indicator 2402 which indicates a stage that the user is at in creating a new meeting. The progress indicator 2402 indicates that the user is at ‘Step 1: Meeting Details’.

The user can enter a name of the meeting in a ‘meeting name’ field 2404, and a date and time for the meeting in date and time field 2406, and can set the meeting as an all day event or a recurring meeting by checking the ‘all day’ and ‘repeat’ boxes respectively. A location of the meeting is entered in a ‘where’ field 2408.

The user can enter a description of the meeting in a ‘description’ field 2410, and is also able to upload one or more documents that are relevant to the meeting by selecting an ‘attachments’ button 2412. This will enable the user to navigate to a location of a desired document that can then be selected for upload.

The user can set a time for a reminder to be sent to meeting participants via a ‘reminder’ field 2414. The user can also select radio buttons 2416 to show the user as ‘busy’ or ‘available’ during the meeting. Further, privacy radio buttons 2418 can be selected to set whether meeting details are ‘private’, available to ‘meeting guests’ (that is, meeting participants) or available to the ‘public’.

When the user has completed setting the meeting details, the user can select a ‘save & continue’ button 2420 to be taken to a ‘manage guests’ page 2500. Alternatively, the user can cancel the created meeting by selecting a ‘cancel’ option 2422.

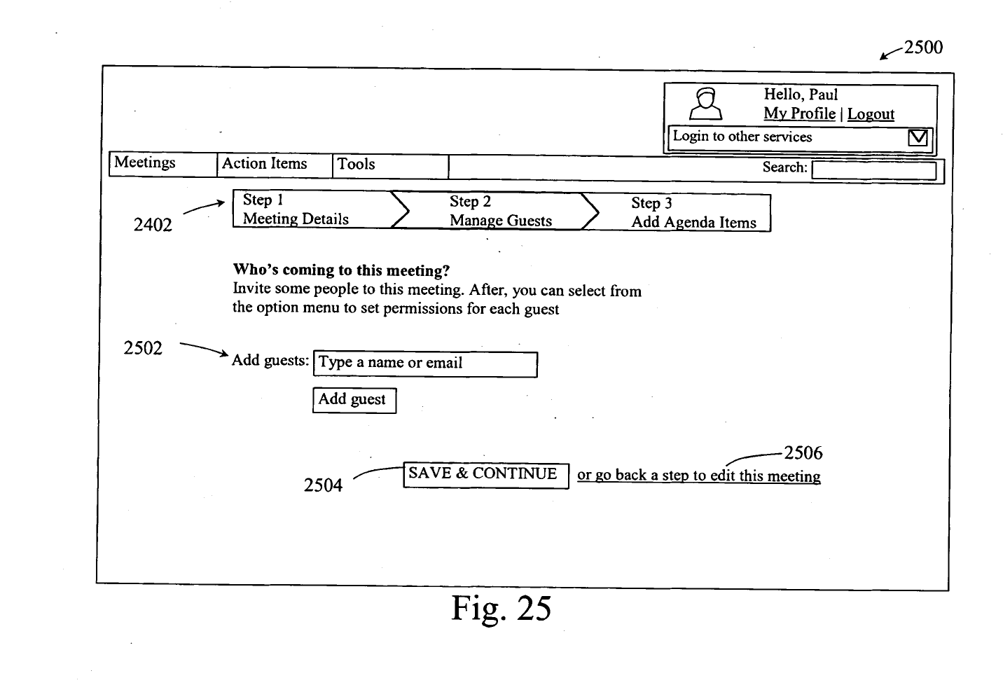

If the user selects the ‘save & continue’ button 2420, the user is presented with the ‘manage guests’ page 2500, as shown in FIG. 25, where the progress indicator 2402 indicates that the user is at ‘Step 2: Manage Guests’. The ‘manage guests’ page 25 enables the user to select meeting participants for inviting to the meeting by entering a meeting participant's name or email address into an ‘add guests’ field 2502.

After entering the desired meeting participants via the ‘manage guests’ page 2500, the user can select a ‘save & continue’ button 2504 to be taken to an ‘add agenda items’ page 2600. Alternatively, the user can return to the ‘meeting details’ page 2400 by selecting a ‘return’ option 2506.

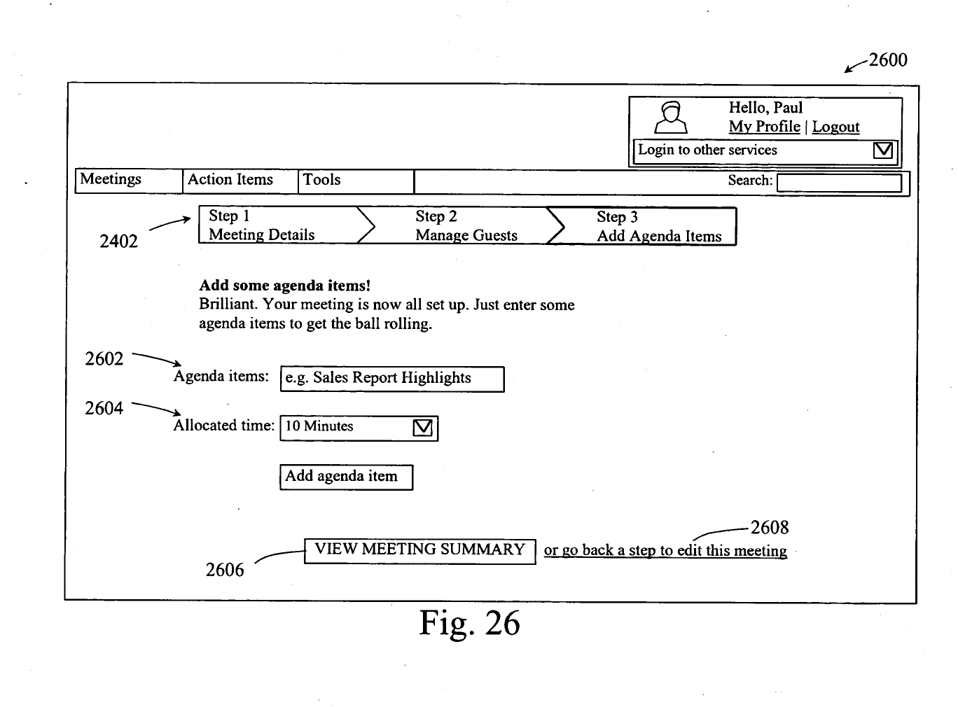

The ‘add agenda items’ page 2600 of FIG. 26 shows, via the progress indicator 2402, that the user is at ‘Step 3: Add Agenda Items’.

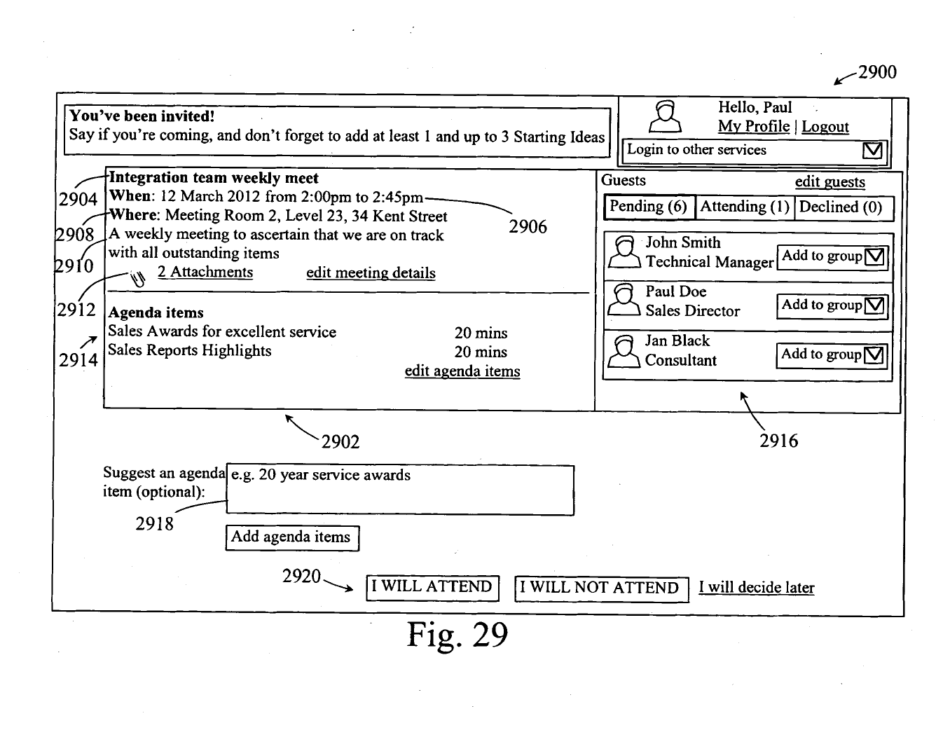

The user is able to enter one or more agenda items for discussion in the meeting into an ‘agenda items’ field 2602. The user is also able to associate a time period for discussing the agenda item by entering time period information into a time field 2604. The system 200 associates the time period information entered into the time field 2604 with an agenda item entered into the ‘agenda items’ field 2602 for later use in displaying remaining time to spend on given agenda items during the meetings. Other users who are invited to the meeting are also able to enter agenda items, as described later in more detail with reference to FIG. 29. The system 200 can be arranged to provide agenda items entered by other users to a meeting facilitator, in this example the user who has created the meeting. The meeting facilitator is then able to select agenda items for inclusion in the meeting. It will be appreciated that the system 200 can be arranged to enable the meeting facilitator to assign and/or adjust a time period associated with each agenda item entered by other users, and to adjust a time period associated with an existing agenda item in the light of agenda items entered by other users. The selected agenda items will be used by the system 200 in creating the meeting structure.

After entering desired agenda items, the user can select a ‘save & continue’ button 2606 to be taken to a ‘send invitation’ page 2700. Alternatively, the user can return to the ‘manage guests’ page 2500 by selecting a ‘return’ option 2608.

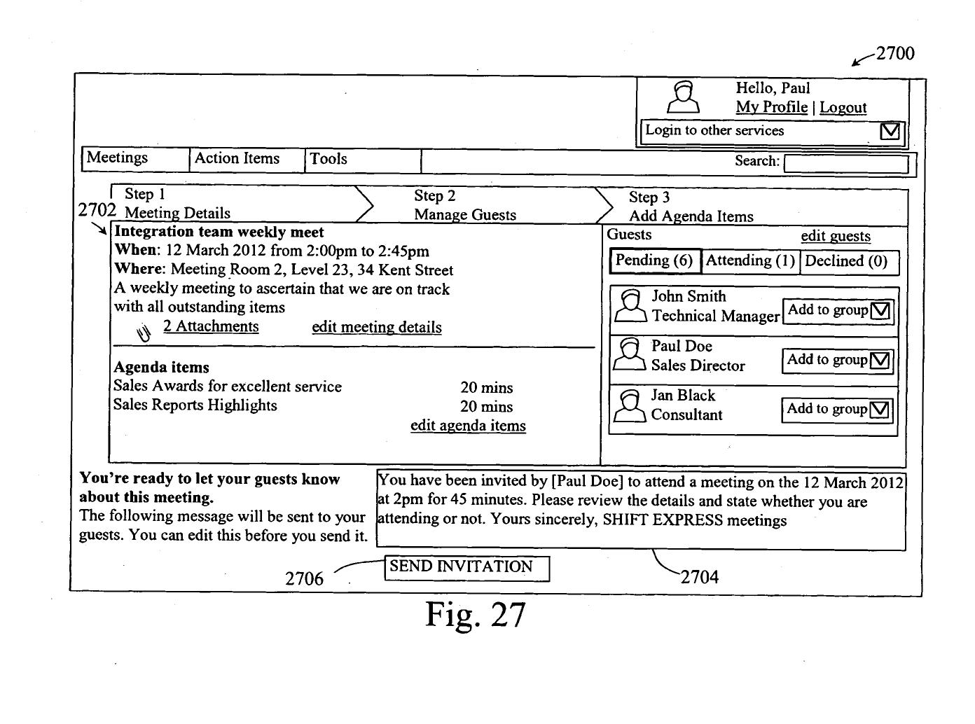

FIG. 27 shows the ‘send invitation’ page 2700, wherein meeting detail information 2702 has been updated to reflect information entered in the previous pages. The user is able to edit invitation information at an invitation information field 2704, and can then send a meeting request to meeting participants by selecting a ‘send invitation’ button 2706.

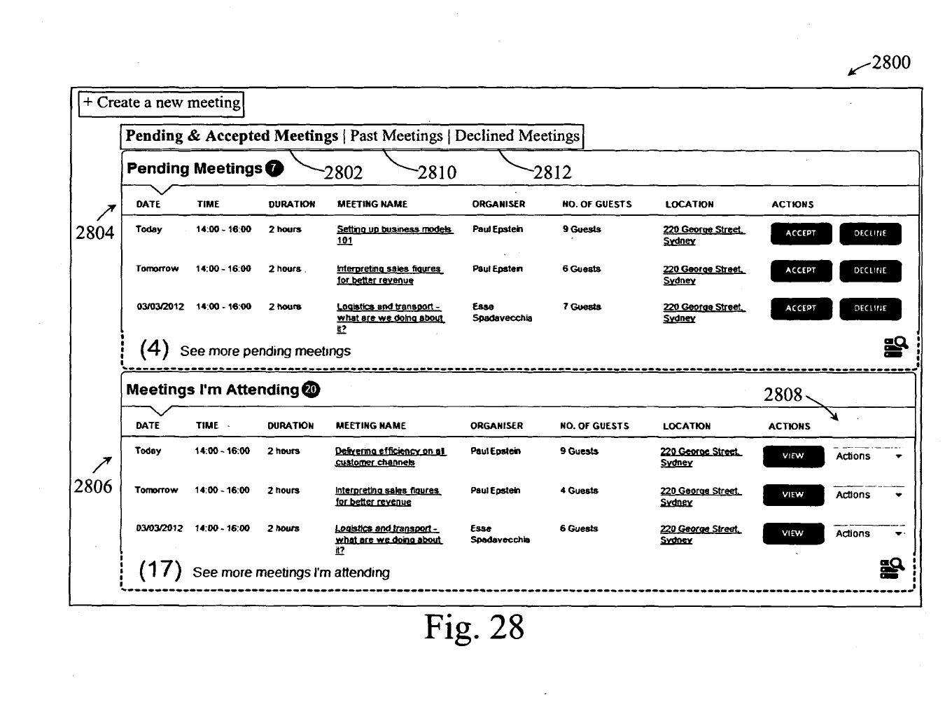

After sending the meeting request, the user is taken to a meetings page 2800 as shown in FIG. 28. The meetings page 2800 comprises a ‘pending and accepted meetings’ tab 2802, selection of which presents a summary of meetings that the user has been invited to and that require the user to ‘accept’ or ‘decline’ by selecting the appropriate button (pending meetings box 2804), and upcoming meetings that the user has accepted (accepted meetings box 2806).

The accepted meetings box 2806 also comprises a drop down actions box 2808 for each upcoming meeting. The user is able to select actions to be performed using the drop down actions box 2808. In one example, the user is able to select the following actions from the drop down actions box 2808: start meeting, add starting idea, resend invitation, duplicate meeting, print meeting, decline meeting, delete meeting.

The user is also able to select a ‘past meetings’ tab 2810 to view details of past meetings, and to select a ‘declined meetings’ tab 2812 to view details of meetings that the user has declined. Providing the user with access to details of past meetings can assist the user in following up on action items, for example.

If the user wishes to create a new meeting, the user is able to select a ‘create new meeting’ icon 2814, which will take the user to the ‘meeting details’ page 2400.

If the user selects a meeting from the ‘pending meetings’ box 2804, the user is taken to a ‘pending meeting’ page 2900 as shown in FIG. 29. The ‘pending meeting’ page 2900 presents the user with details of the meeting to which the user has been invited in a meetings details box 2902. The meeting details box 2902 will present the user with a meeting name 2904, a meeting time 2906, a meeting location 2908, a meeting description 2910, a link to meeting attachments 2912, meeting agenda items 2914 with their associated time periods, and a guest list 2916. In this example, the guest list 2916 indicates which guests are yet to accept or decline the meeting invitation, which guests are attending, and which guests have declined the meeting invitation.

The ‘pending meeting’ page 2900 also comprises a ‘suggest an agenda item’ field 2918, in which the user can add one or more agenda items that may be relevant to the meeting.

It will be appreciated that each user can enter one or more agenda items, and the system 200 is arranged to receive entered agenda items from each user for inclusion in the meeting structure.

The user is also able to ‘accept’, ‘decline’ or defer a decision to accept or decline by electing an option from ‘meeting attendance’ buttons 2920.

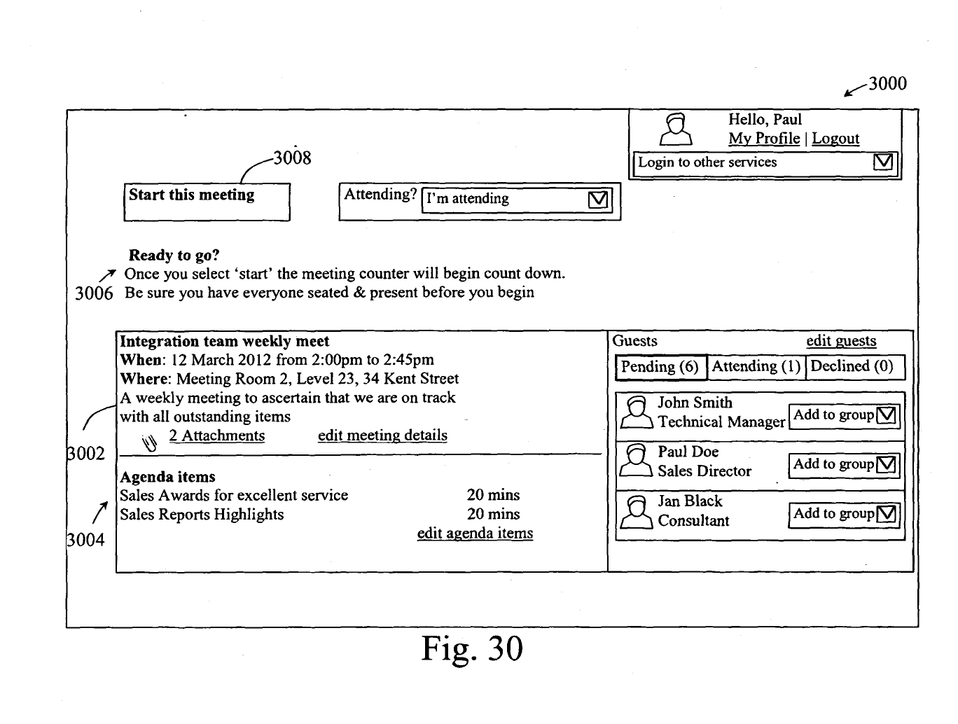

When the meeting is ready to take place, the user, who may be a facilitator of the meeting, is presented with a ‘start meeting’ page 3000 as shown in FIG. 30. The ‘start meeting’ page 3000 comprises a meeting details box 3002 that presents the user with relevant meeting details. The meeting details box 3002 also comprises agenda items 3004, corresponding to agenda items that were entered when the meeting was created and/or by meeting participants from their respective ‘pending meeting’ page 2900.

The ‘start meeting’ page 3000 also comprises meeting guidance information 3006 that facilitates the user in running the meeting. In this example, the meeting guidance information has been generated by the system 200, and reminds the user to ensure that meeting participants are seated and present before beginning the meeting. It will be appreciated that the meeting may be virtual, in which case the meeting guidance information may remind the user to begin the meeting when meeting participants have logged into the virtual meeting room.

The user is able to begin the meeting by selecting a ‘start this meeting’ button 3008.

Once the meeting has begun, the system 200 presents the user with a structured series of pages to assist the user in facilitating the meeting. The system 200 uses the time periods allocated to the agenda items of the meeting and prompts the user with a sequence of steps to take for each stage of the meeting. The system 200 also assigns time periods to typical stages of the meeting, such as an ‘agenda overview’ stage and a ‘summary and close’ stage. The system 200 also enables the user to enter information gathered from the meeting, such as further ideas or outcomes that arise from the meeting.

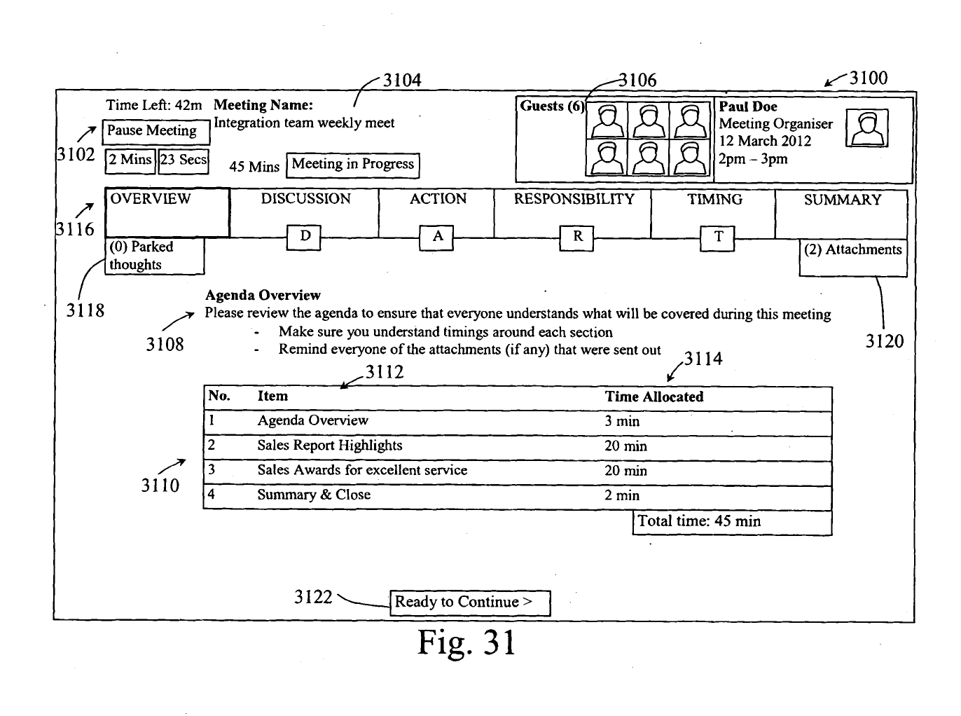

In a first stage of the meeting, the system 200 presents the user with an ‘agenda overview’ page 3100 as shown in FIG. 31. The ‘agenda overview’ page 3100 comprises time information 3102 which indicates time remaining in the meeting, and time remaining for a current meeting stage. In this example, the meeting stage is an ‘overview’ stage, and the time information 3102 indicates that there are 42 minutes left in the meeting, and 2 minutes and 23 seconds remaining to complete the ‘overview’ stage of the meeting. The system 200 is arranged to alert the user if the ‘overview’ stage of the meeting exceeds the time period allocated for the ‘overview’ stage. The system 200 is arranged to provide similar alerts for further meeting stages if the time period of any meeting stage exceeds its respective allocated time period. The system 200 is also arranged to provide an early warning alert prior to the time period being exceeded, for example 2 minutes prior to the time period being exceeded.

It will be appreciated that the system 200 may also be arranged to generate an alert if the total amount of time spent on the meeting exceeds a suggested meeting length time that is provided to the system 200 or generated by the system 200. The system 200 may also generate an early warning alert prior to the suggested meeting time length being exceeded, for example when there are 5 minutes left in the meeting.

The ‘agenda overview’ page 3100 also displays meeting name information 3104, which corresponds to the meeting name input to the meeting name field 2404 of the ‘meeting details’ page 2400. A list of meeting participants 3106 is also displayed, corresponding to meeting participants who ‘accepted’ the meeting request.

The ‘agenda overview’ page 3100 also comprises agenda overview stage information 3108. The information 1308 is used to prompt the user with steps to facilitate progressing through the ‘agenda overview’ stage. In this example, the information 3108 reminds the user to review the meeting overview to review the agenda to ensure that the meeting participants understand what will be covered during the meeting. The information 3108 also prompts the user to ensure that the user understand time periods associated with each meeting stage and reminds the meeting participants of any meeting attachments that were associated with the meeting.

The ‘agenda overview’ page 3100 also comprises agenda overview information 3110. The agenda overview information 3110 lists meeting stages 3112 and a time period 3114 associated with each meeting stage 3112 (including a total meeting time at a bottom of the list of time periods 3114).

The ‘agenda overview’ page 3100 also comprises meeting stage progress information 3116, listing an order of meeting stages, and indicating that the meeting is presently at the ‘overview’ stage. The stages identified in the meeting stage progress information 1316 progress through the following: ‘overview’, ‘discussion’, ‘action’, ‘responsibility’, ‘timing’ and ‘summary’. In this example, the ‘overview’ and ‘summary’ stages correspond to the ‘agenda overview’ and ‘summary & close’ items listing in the meeting stages 3112 respectively. The ‘discussion’, ‘action’, ‘responsibility’ and ‘timing’ stages are repeated for each agenda item.

Below the meeting stage progress information 3116 is a ‘parked thoughts’ icon 3118. Throughout the meeting, the user can select the ‘parked thoughts’ icon 3118 to enter any relevant points, issues, thoughts, opinions or the like (parked thoughts') that are raised during the meeting. The user can return to any ‘parked thoughts’ at any time during the meeting by selecting the parked thoughts' icon 3118 for discussion.

Also below the meeting stage progress information 3116 is an ‘attachments’ icon 3120. Selecting the ‘attachments’ icon 3120 will present any attachments that are associated with the meeting. This provides the user with quick access to the relevant meeting attachments.

When the user is ready to progress to the next page, an ‘agenda item 1’ page 3200, the user is able to select a next meeting stage button 3122.

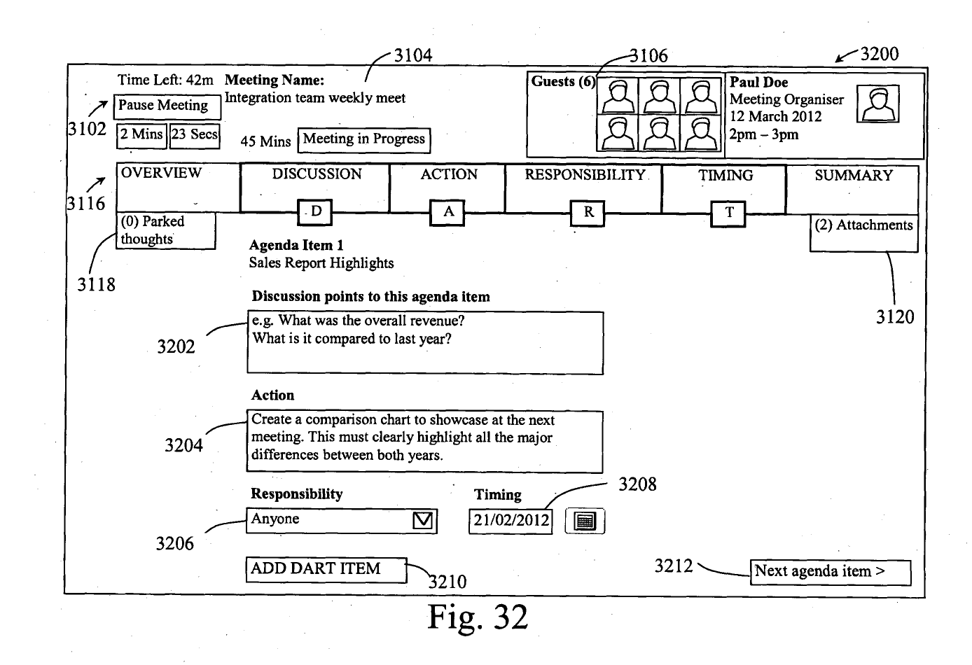

In a second stage of the meeting, the system 200 presents the user with the ‘agenda item 1’ page 3200 as shown in FIG. 32. The ‘agenda item 1’ page 3200 comprises a number of fields that are used to prompt the user through a first agenda item. In this example, the ‘agenda item 1’ page 3200 comprises a discussion field 3202 for entering information in respect of discussions related to the first agenda item.

After entering discussion information in to the discussion field 3202, the user is able to enter action information into an action field 3204. The action information relates to decided actions to take in respect of the first agenda item.

The user is then able to assign a person who is responsible for completing any actions identified by the action information. The user can assign this responsibility by selecting a person, such as a meting participant, via a ‘responsibility’ drop down box 3206. The user can also associate a time for completion of any actions by entering timing information into a time information box 3208.

It will be appreciated that each of the ‘discussion’, ‘action’, ‘responsibility’ and ‘timing’ stages of the first agenda item are facilitated by entering information into the respective fields/boxes 3202, 3204, 3206, 3208.

Upon completion, the user is able to save the entered information by selecting an ‘add dart item’ icon 3210, and the entered information is saved by the system 200 for use in generating a meeting report when the meeting has concluded.

The ‘agenda item 1’ page 3200 also comprises a next meeting stage button 3212, selection of which will take the user to an ‘agenda item 2’ page 3300.

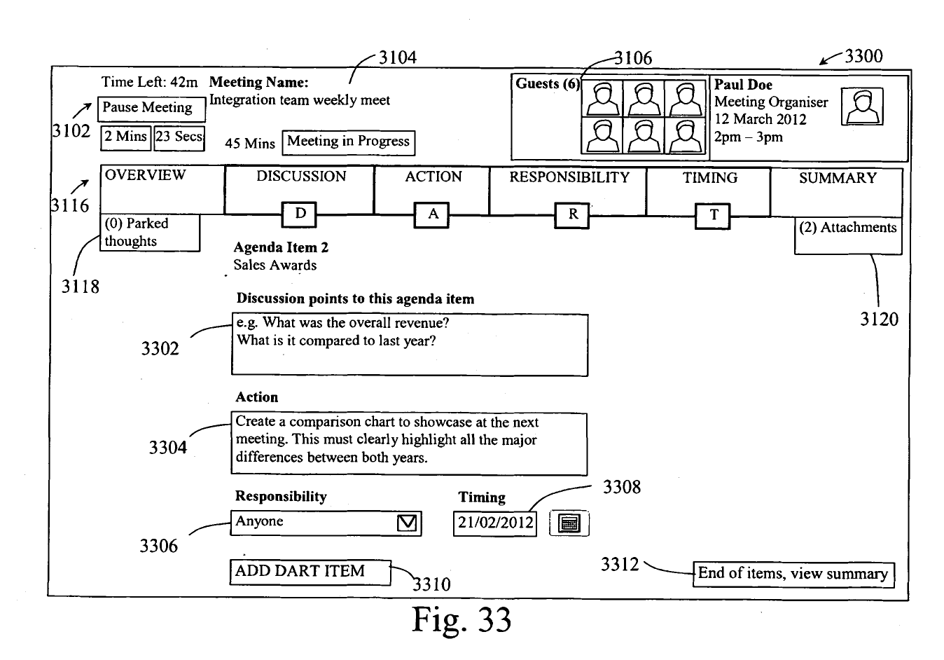

In a third stage of the meeting, the system 200 presents the user with the ‘agenda item 2’ page 3300 as shown in FIG. 33. The ‘agenda item 2’ page 3300 comprises a number of fields that are used to prompt the user through a second agenda item. In this example, the ‘agenda item 2’ page 3300 comprises a discussion field 3302 for entering information in respect of discussions related to the second agenda item.

After entering discussion information in to the discussion field 3302, the user is able to enter action information into an action field 3304. The action information relates to decided actions to take in respect of the second agenda item.

The user is then able to assign a person who is responsible for completing any actions identified by the action information. The user can assign this responsibility by selecting a person, such as a meting participant, via a ‘responsibility’ drop down box 3306. The user can also associate a time for completion of any actions by entering timing information into a time information box 3308.

As with the ‘agenda item 1’ page 3200, It will be appreciated that each of the ‘discussion’, ‘action’, ‘responsibility’ and ‘timing’ stages of the second agenda item are facilitated by entering information into the respective fields/boxes 3302, 3304, 3306, 3308.

Upon completion, the user is able to save the entered information by selecting an ‘add dart item’ icon 3310, and the entered information is saved by the system 200 for use in generating a meeting report when the meeting has concluded.

The ‘agenda item 2’ page 3300 also comprises a next meeting stage button 3312, selection of which will take the user to a ‘summary’ page 3400.

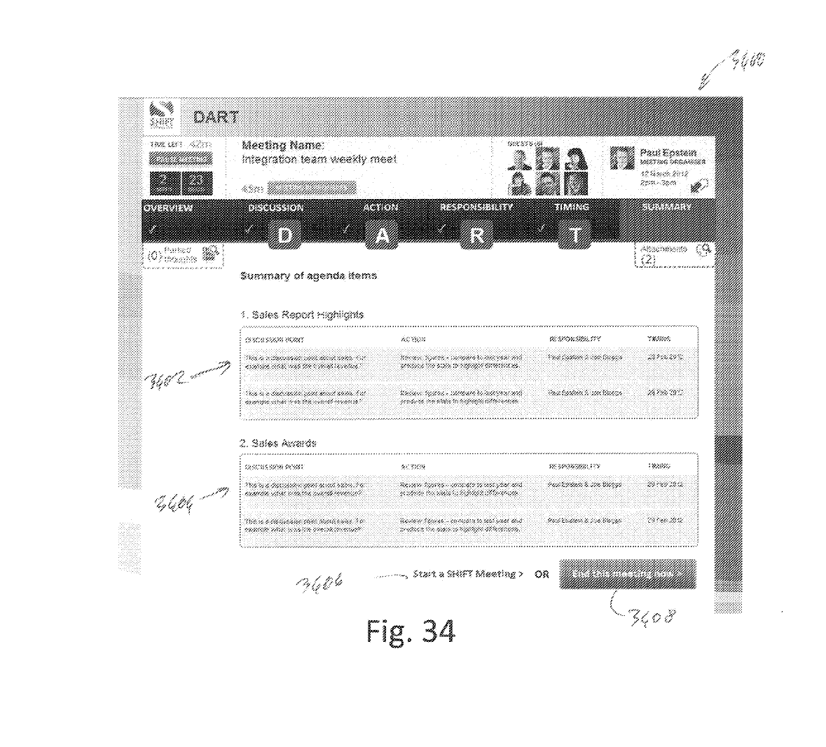

In a fourth stage of the meeting, the system 200 presents the user with the ‘summary’ page 3400 as shown in FIG. 34. The ‘summary’ page 3400 comprises a summary of information entered in respect of agenda items during the meeting. In this example, the ‘summary’ page 3400 comprises a ‘first agenda item’ summary information box 3402 that comprises information entered in respect of the first agenda item, and a ‘second agenda item’ summary information box 3404 comprising information entered in respect of the second agenda item.

The ‘summary’ page 3400 also comprises a ‘start SHIFT meeting’ option 3406, selection of which will conveniently begin a meeting based on the SHIFT meeting stages as described earlier with reference to FIGS. 3 to 22. A SHIFT-based meeting that begins in this way can incorporate agenda items that were just discussed using the DART-based meeting stages. For example, the system 200 can be arranged to import agenda items from the DART-based meeting as ‘starting ideas’ in a SHIFT-based meeting.

Alternatively, the user can select an ‘end this meeting’ button 3408 to be taken to a ‘send summary’ page 3500.

When the meeting has concluded, the system 200 generates a meeting report which can be communicated to the meeting participants or other recipients as desired. The system 200 generates the report based on information entered when the meeting was created, and based on information entered during the meeting. In one example, the meeting report comprises information displayed with respect to the first and second agenda item information boxes 3402, 3404 of FIG. 34.

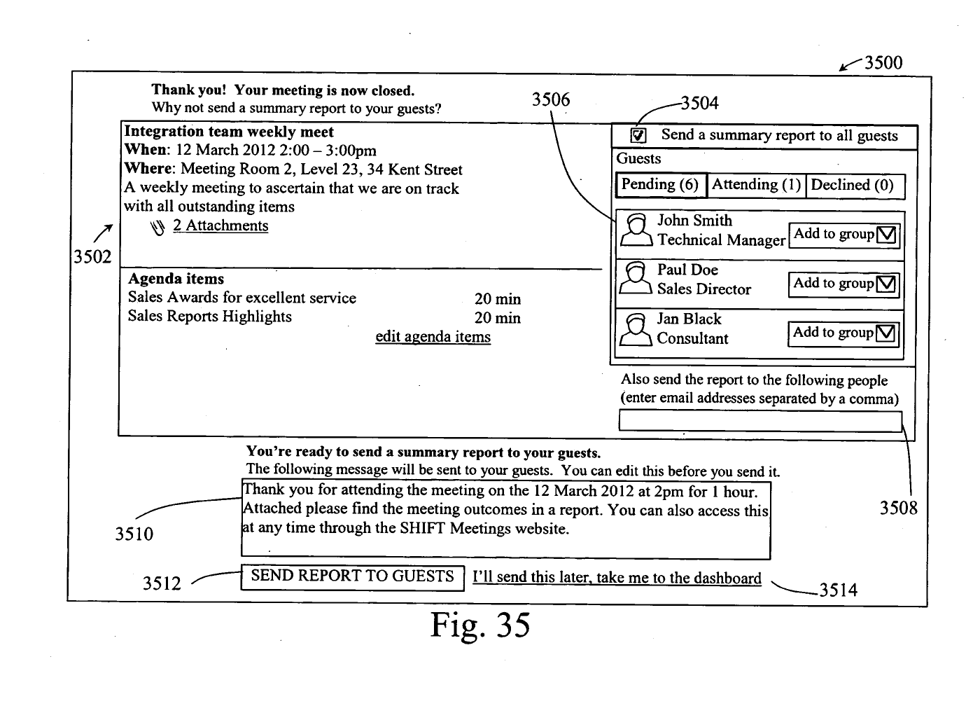

FIG. 35 shows the ‘send summary’ page 3500. The ‘send summary’ page 3500 shows meeting detail information 3502, including a check box 3504 for selecting to send a generated meeting report to the meeting participants shown in meeting participant box 3506. The user is also able to enter additional recipients of the generated meeting report via a recipient field 3508. Prior to sending the generated meeting report, the user can edit meeting summary information at a meeting summary information field 3510, and can then send the meeting report to meeting participants by selecting a ‘send report to guests’ button 3512. Alternatively, the user can return to a dashboard page (not shown) by selecting a ‘return’ option 3514.

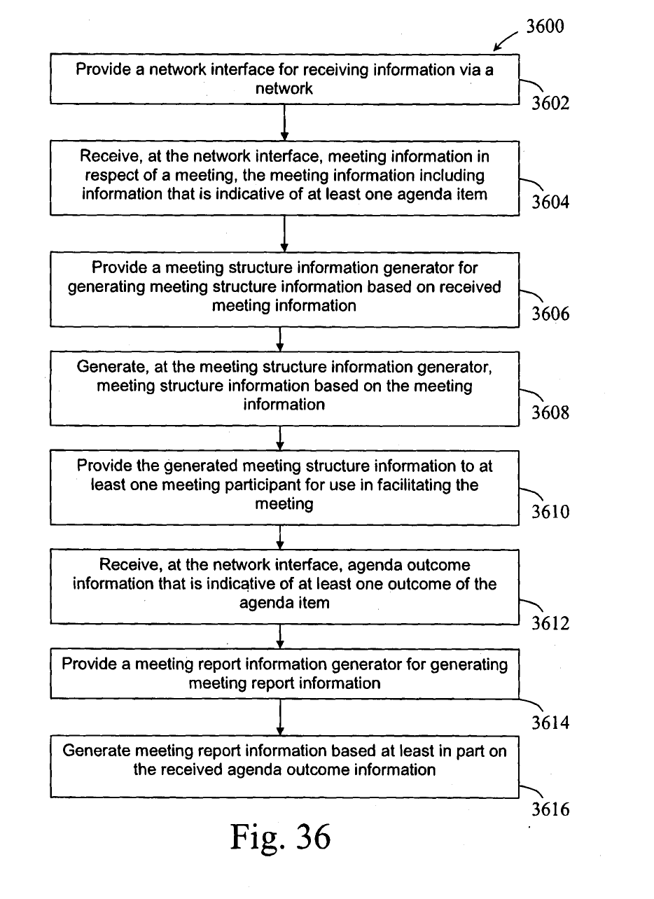

FIG. 36 shows a flow diagram of a method 3600 of facilitating a meeting. The method 3600 comprises a first step 3602 of providing a network interface for receiving information via a network. In a second step 3604 meeting information in respect of a meeting is received at the network interface. The meeting information includes information that is indicative of at least one agenda item.

In a third step 3606, the method comprise providing a meeting structure information generator for generating meeting structure information based on the meeting information received in the second step 3604. In a fourth step 3608, meeting structure information based on the meeting information is generated at the meeting structure information generator.

In a fifth step 3610, the generated meeting structure information is provided to at least one meeting participant for use in facilitating the meeting. In a sixth step 3612, agenda outcome information that is indicative of at least one outcome of the agenda item is receives at the network interface.

In a seventh step 3614, a meeting report information generator for generating meeting report information is provided and the meeting report information generator is used, in an eighth step 3616, to generate meeting report information based at least in part on the received agenda outcome information.

It will be appreciated that one or more of the above described methods can be implemented as a computer program arranged, when loaded into a computing device, to instruct the computing device to operate in accordance with, for example, the method 3600 of FIG. 36.

It will also be appreciated that one or more of the above described methods can be implemented as a computer readable medium having a computer readable program code embodied therein for causing a computing device to operate in accordance with, for example, with the method 3600 of FIG. 36.

It will also be appreciated that one or more of the above described methods can be implemented as a data signal having a computer readable program code embodied therein to cause a computing device to operate in accordance with, for example, the method 3600 of FIG. 36.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

For example, it will be appreciated that the meeting can be virtual, meeting participants can attend in person, or the meeting may comprises a combination of both real and virtual meeting participants.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

What is claimed is:

1. A method of facilitating a meeting, the method comprising the steps of:
providing a network interface for receiving information via a network;
receiving, at the network interface, meeting information in respect of a meeting, the meeting information including information that is indicative of at least one agenda item;
providing a meeting structure information generator for generating meeting structure information based on received meeting information;
generating, at the meeting structure information generator, meeting structure information based on the meeting information;
providing the generated meeting structure information to at least one meeting participant for use in facilitating the meeting;
receiving, at the network interface, agenda outcome information that is indicative of at least one outcome of the agenda item;
providing a meeting report information generator for generating meeting report information; and
generating, at the meeting report information generator, meeting report information based at least in part on the received agenda outcome information.

2. The method of claim 1, further comprising the step of communicating the generated meeting report information to meeting participants.

3. The method of claim 1, wherein the meeting structure information is generated such that information indicative of a suggested time period is associated with the at least one agenda item.

4. The method of claim 3, wherein the method comprises a step of tracking an amount of time spent on the at least one agenda item during the meeting, and generating an alert if the amount of time spent on the at least one agenda item exceeds the suggested time period associated with the at last one agenda item.

5. The method of claim 1, wherein the meeting structure information is generated such that at least one predefined meeting step is associated with the at least one agenda item.

6. The method of claim 5, further comprising a step of prompting a meeting participant with information related to the at least one predefined meeting step so as to facilitate the at least one predefined meeting step being conducted.

7. The method of claim 6, wherein a plurality of defined meeting steps are associated with the at least one agenda item, and the method comprises prompting the meeting participant with information associated with each meeting step so as to facilitate the predefined meeting steps being conducted.

8. The method of claim 1, comprising:
receiving information indicative of a further agenda item and/or a modification to an existing agenda item; and
generating the meeting structure information so as to incorporate the further agenda item and/or the modification to the existing agenda item.

9. The method of claim 1, comprising the steps of:
receiving at least one action information item associated with a meeting item to be actioned;
receiving information indicative of a meeting participant selected to complete the action item; and
communicating the at least one action information item to the selected meeting participant.

10. The method of claim 9, comprising the steps of:
receiving time information indicative of a suggested completion time of the at least one action item; and
communicating the received time information indicative of a suggested completion time of the at least one action to the selected meeting participant so as to facilitate the selected meeting participant completing the action item by the suggested completion time.

11. A system for facilitating a meeting, the system comprising:
a network interface that is in communication with a network, the network interface being arranged to receive, via the network, meeting outline information in respect of a meeting, the meeting outline information including at least one agenda item;
a meeting structure information generator arranged to generate meeting structure information based on the meeting outline information;
the system being arranged to:
communicate the generated meeting structure information to at least one meeting participant for use in facilitating the meeting; and
receive agenda outcome information that is indicative of at least one outcome of the agenda item;
the system further comprising a meeting report information generator arranged to generate meeting report information based at least in part on the received agenda outcome information.

12. The system of claim 11, wherein the system is arranged to communicate the generated meeting report information to meeting participants.

13. The system of claim 11, wherein the system is arranged to generate the meeting structure information such that information indicative of a suggested time period is associated with the at least one agenda item.

14. The system of claim 13, wherein the system is arranged to track an amount of time spent on the at least one agenda item during the meeting, and to generate an alert if the amount of time spent on the at least one agenda item exceeds the suggested time period associated with the at last one agenda item.

15. The system of claim 11, wherein the system is arranged to generate the meeting structure information such that at least one predefined meeting step is associated with the at least one agenda item.

16. The system of claim 15, wherein the system is arranged to prompt a meeting participant with information related to the at least one predefined meeting step so as to facilitate the at least one predefined meeting step being conducted.

17. The system of claim 16, wherein a plurality of defined meeting steps are associated with the at least one agenda item, and the system is arranged to prompt the meeting participant with information associated with each meeting step so as to facilitate the predefined meeting steps being conducted.

18. The system of claim 11, wherein the system is arranged to:
receive information indicative of a further agenda item and/or a modification to an existing agenda item; and
generate the meeting structure information so as to incorporate the further agenda item and/or the modification to the existing agenda item.

19. The system of claim 11, wherein the system is arranged to:
receive at least one action information item associated with a meeting item to be actioned;
receive information indicative of a meeting participant selected to complete the action item; and
communicate the at least one action information item to the selected meeting participant.

20. The system of claim 19, wherein the system is arranged to:
receive time information indicative of a suggested completion time of the at least one action item; and
communicate the received time information indicative of a suggested completion time of the at least one action to the selected meeting participant so as to facilitate the selected meeting participant completing the action item by the suggested completion time.
